(19) United States
(12) Patent Application Publication
(10) Pub. No.: US 2026/0119464 A1
(43) Pub. Date: Apr. 30, 2026

(54) CONSISTENT SCALABLE REPLICATION OVER DISPARATE DATA MODELS AND STORAGE SYSTEMS

(71) Applicant: Oracle International Corporation, Redwood Shores, CA (US)

(72) Inventor: Raman Grover, Palo Alto, CA (US)

(73) Assignee: Oracle International Corporation, Redwood Shores, CA (US)

(21) Appl. No.: 19/364,178

(22) Filed: Oct. 21, 2025

Related U.S. Application Data
(60) Provisional application No. 63/712,369, filed on Oct. 25, 2024.
(60) Provisional application No. 63/711,943, filed on Oct. 25, 2024.

(51) Int. Cl. G06F 16/21; G06F 16/22; G06F 21/16

(52) U.S. Cl. CPC G06F 16/211; G06F 16/2282; G06F 21/16

(57) ABSTRACT

Techniques are disclosed for consistent and scalable replication between source and target data stores in heterogeneous data environments. In one aspect, a method includes receiving, by a data storage system, a source data write from a source data store. The source data write is executed on a replica data store and a transaction is determined based on one or more data operations of the source data write. A router identifies one or more materializers based on the transaction and a mapping between a first schema and a second schema. The materializers generate one or more semantic objects based on the transaction, and the semantic objects are transmitted to target data stores. For each semantic object, the materializers generate a watermark based on a replica data store read timestamp. The data storage system may receive multiple writes causing race conditions that are resolved based on the watermarks and read timestamps.

### CROSS-REFERENCE TO RELATED APPLICATIONS

The present application is a non-provisional application of and claims the benefit and priority under 35 U.S. C. 119(e) of U.S. Application 63/712,369, filed on Oct. 25, 2024 and U.S. Application 63/711,943, filed on Oct. 25, 2024, the disclosures of which are incorporated herein by reference in their entirety for all purposes.

### FIELD

The present disclosure relates generally to data systems, and more particularly, to techniques for improved data replication in distributed data storage systems.

### BACKGROUND

Heterogeneous and disparate data stores can make computing and querying data more flexible and efficient. Applications that interface with the data storage systems can better query data that suit their needs, rather than being limited to a particular type of data query or store. The data storage system can also scale better to better optimize for different workloads.

In recent years, there has been a significant rise in capabilities of data storage systems. In particular, improvements in natural language processing (NLP) have increased the abilities of data storage systems to store semantic concepts of data stored with the storage system. Managing and processing data across various components, particularly for data storage systems with disparate data stores, data models, or the like can be difficult to maintain.

The improvement of data storage systems represents a significant advancement in making data storage systems more accessible and accurate. By improving capabilities of data storage systems, these systems can improve access to information across applications. This disclosure presents techniques related to improved data replication techniques in distributed data storage systems.

### BRIEF SUMMARY

Data replication techniques are disclosed herein (e.g., computer-implemented methods, systems, non-transitory computer-readable media storing code or instructions executable by one or more processors) for intent-based replication of data from source to target systems enabling efficient and flexible data replication across data systems.

In some embodiments, a computer-implemented method includes receiving, by a data storage system, a source data write from a source data store, wherein: the source data write is (i) a direct write to the source data store, (ii) a duplicated write from the data storage system, or (iii) a combination thereof, the source data store is associated with a first schema, and the data storage system is associated with a second schema that is different from the first schema; executing the source data write on a replica data store of the data storage system, wherein the replica data store is associated with the first schema; determining a transaction based on one or more data operations of the source data write; identifying, by a router, one or more materializers based on the transaction and a mapping between the first schema and the second schema; transmitting, by the router, the transaction to the one or more materializers; generating, by the one or more materializers, one or more semantic objects based on the transaction; and transmitting the one or more semantic objects to one or more target data stores of the data storage system, wherein the one or more target data stores are associated with the second schema.

In some embodiments, the one or more target data stores comprise a first target data store corresponding to a first data store type and a second target data store corresponding to a second data store type; and the computer-implemented method further comprises: performing, on the first target data store, a first write operation comprising the one or more semantic objects; generating, based on the first write operation, one or more converted semantic objects by converting the one or more semantic objects to a format corresponding to the second data store type; and performing, on the second target data store, a second write operation comprising the one or more converted semantic objects.

In some embodiments, identifying the one or more materializers comprises: identifying, based on the transaction, one or more updated tables corresponding to the first schema; identifying, based on the mapping, one or more concepts associated with the one or more updated tables, wherein the one or more concepts are defined by the second schema; determining, based on the one or more concepts, the one or more semantic objects; and identifying, for each semantic object of the one or more semantic objects, a corresponding materializer of the one or more materializers, wherein generating the one or more semantic objects comprises generating each semantic object of the one or more semantic objects using the corresponding materializer based on the transaction.

In some embodiments, transmitting the transaction comprises: generating, based on the transaction, one or more data capture transactions, wherein each of the one or more data capture transactions comprise at least a subset of the one or more data operations; and for each data capture transaction of the one or more data capture transactions: identifying, by a dispatcher, a semantic object queue corresponding to a relevant materializer of the one or more materializers, and appending the data capture transaction to the semantic object queue corresponding to the relevant materializer.

In some embodiments, generating the one or more semantic objects comprises, for each materializer of the one or more materializers: identifying a primary key associated with the transaction, wherein the primary key corresponds to a semantic object; determining, based on the second schema, one or more relevant values associated with the primary key; retrieving the one or more relevant values from the replica data store; determining a watermark based on the retrieving, wherein the watermark comprises a timestamp; and generating the semantic object based on the one or more relevant values and the watermark.

In some embodiments, the computer-implemented method further includes receiving, at the data storage system, a second source data write from the source data store, wherein the second source data write corresponds to the one or more semantic objects; generating a version of the one or more semantic objects based on the second source data write, wherein the version is associated with a second watermark; determining whether the watermark is greater than the second watermark; responsive to determining the watermark is greater than the second watermark, writing the one or more semantic objects to the one or more target data stores; and responsive to determining the watermark is not greater than the second watermark, executing the second source data write on the one or more target data stores.

In some embodiments, the source data write is a duplicated write from the data storage system, and the computer-implemented method further comprises: receiving, at the data storage system, a direct data write; generating the source data write based on the direct data write; transmitting the duplicated write to the source data store; generating a placeholder watermark based on the direct data write and a current time value; determining whether the placeholder watermark corresponds to an expected watermark value; and responsive to determining the placeholder watermark corresponds to the expected watermark value, executing the direct data write on the one or more target data stores.

In some embodiments, the source data write is a duplicated write from the data storage system, and the computer-implemented method further comprises: receiving, at the data storage system, a target data write; generating the source data write based on the target data write; generating a direct watermark based on the target data write; and writing, at the one or more target data stores, the one or more semantic objects corresponding to (i) the target data write, (ii) the source data write, (iii) the second source data write, or (iv) a combination thereof, based on the watermark, the second watermark, and the direct watermark.

In some embodiments, the computer-implemented method further includes receiving, by the data storage system, a query for a semantic object from a user; retrieving the semantic object from a target data store of the one or more target data stores; and providing the semantic object to the user.

Some embodiments include a system that includes one or more processors; and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a computing environment of a disparate data storage system, in accordance with various embodiments.

FIG. 2 is an example of an architecture for a computing environment for a data storage system implemented with an ingestion flow for disparate data stores, in accordance with various embodiments.

FIG. 3 depicts an exemplary data flow for mapping a transaction including data changes from a first schema to a second schema, in accordance with various embodiments.

FIG. 4 depicts an exemplary routing subsystem 400 including a router and materializer for transforming data operation ingested from a source data store to a target data store, in accordance with various embodiments.

FIG. 5 is a simplified block diagram of a process for replicating a data transaction from a source data store to a target data store, in accordance with various embodiments.

FIG. 6 is a flowchart of a process for resolving a first race condition when replicating data from a source data store to a target data store, in accordance with various embodiments.

FIG. 7 is a flowchart of a process for resolving a second race condition when replicating data from a source data store to a target data store within SI, in accordance with various embodiments.

FIG. 8 is a flowchart of a process for resolving a third race condition when replicating data from a source data store to a target data store within SI, in accordance with various embodiments.

FIG. 9 is a flowchart of a process for consistent and scalable replication of data from a source data system to a target data system, in accordance with various embodiments.

FIG. 10 is a block diagram illustrating one pattern for implementing a cloud infrastructure as a service system, in accordance with various embodiments.

FIG. 11 is a block diagram illustrating another pattern for implementing a cloud infrastructure as a service system, in accordance with various embodiments.

FIG. 12 is a block diagram illustrating another pattern for implementing a cloud infrastructure as a service system, in accordance with various embodiments.

FIG. 13 is a block diagram illustrating another pattern for implementing a cloud infrastructure as a service system, in accordance with various embodiments.

FIG. 14 is a block diagram illustrating an example computer system, in accordance with various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Introduction

In recent years, the amount of data powering various industries and their systems has been increasing exponentially. Organizations and businesses store and consume data across various types of data stores (e.g., relational databases, non-relational databases, object stores, key-value stores, file storage, etc.). These data stores power information systems across multiple industries, for instance, consumer tech (e.g., orders, cancellations, refunds), supply chain (e.g., raw materials, stocks, vendors), healthcare (e.g., medical records), finance (e.g., financial business metrics), customer support, search engines, and much more. Data that powers these industries can come from a variety of different sources and it is imperative for modern data-driven organizations to maintain consistent and reliable data to provide accurate representations of data to users.

With the rise of natural language (NL) processing and artificial intelligence capabilities, storing and providing data in ways that maintain semantic coherence and meaning can improve user queries and interactions with data storage systems. It is vastly more efficient for non-technical users (e.g., business leaders, doctors, or other users of the data) directly interact with the analytics tables via natural language (NL) queries that abstract away underlying query language and/or data structures of a data storage system. Further, for data storage systems with multiple sources of data reflected within the storage systems, querying the system with a single unified structure can make accessing data more efficient and reduce user burden. By providing unified query and storage structures, even technical users with strong understandings of one type of data storage but lacking knowledge in other types of data storage can better query a data storage system based on types of data storage and querying implementations they are comfortable with.

Implementing a Semantic Object Model in a data environment with disparate and/or distributed data stores can be a powerful tool for unifying data across the data stores while providing efficient access to data. Unlike other data models, which often only define objects by structure, a Semantic Object Model can define objects by their semantic meaning and relationships. Objects are represented as concepts associated with various attributes and relationships that can be leveraged to determine semantics and meaning. For example, in a healthcare environment, a patient can be represented as a concept, and semantic objects (SOs) corresponding to a patient concept can include various attributes that can describe the patient such as name, address, phone number, and the like. In some implementations, semantic objects can include self-describing metadata and/or linked actions for custom operations.

A particular challenge in implementing a data storage system containing combinations of disparate and distributed data stores, however, is maintaining consistency across the various data models, schemas, and data store types in the data storage system. This challenge is especially relevant in data storage systems that are designed to be consistent with an external source data system (e.g., a source data store). An eventual consistency model may guarantee that updates to a distributed database are eventually reflected in all nodes (e.g., data stores) that store the data. In such consistency models, a data store may still be available, and data can be queried to retrieve the last updated value without waiting for all data stores to fully reflect current data. This can be especially important in environments such as healthcare systems where consistent access to data can be crucial. However, conventional solutions for eventual consistency often implement data replication techniques that assume a source data system and target data system implement identical data models and/or schemas. For example, data replication techniques that provide near real-time replication often replicate transactions capturing record-level changes committed to a source data store and/or copy statements executed on a source system to a target system. In a heterogeneous data environment, however, a statement executed on a source data store may not be executable on a target data store and replicating record-level changes can be difficult due to differences in schemas. Consequently, conventional data replication techniques may be unsuitable for heterogeneous data environments including data stores with different schemas, data models, data store types, or combinations thereof.

Additionally, parallelization of data writes can be important for achieving scalability of data ingestion and replication. Preserving commit order (e.g., committing data writes to a target system in the order the data writes were committed to the source system) and processing data writes in sequential order can increase latency of data replication and data ingestion, preventing the data system from processing data in a scalable manner. Furthermore, increased latency in data ingestion can increase the lag between executing data writes on the source system and replicating the data writes on data stores of a target system, which can reduce real-time accuracy of data stored within the target system. As such, parallelizing data writes and data write execution can improve latency and scalability of data ingestion. Parallelization of data writes can be particularly efficient when data writes are directed towards different data within a data store or data system. However, parallelizing data replication can introduce additional challenges in ensuring written data is accurate and that old data is not overwritten during a data ingestion process. In particular, when two data writes received at the source data system change the same data, processing data writes in parallel may result in an older data write overwriting a newer data write if the newer data write is processed and replicated before the older data write.

Furthermore, some heterogeneous data environments may be multi-master data environments, which can introduce additional challenges for maintaining consistency between heterogeneous data stores. In such data environments, issues related to data correctness can arise in instances where a where both source and target systems receive parallel data writes. In such cases, a direct write to the target system may be processed and executed significantly before a data write ingested from the source system can be processed and executed on the target system. For example, a source data write can be executed on a source data system and a direct data write can subsequently be executed on the target data system. Depending on implementations of the systems, a lag may exist between a write executed on the source data system, and the write being propagated to the target data system. As such, the direct write to the target system may be executed first, before the source write to the source data system is propagated to the target system. However, older source data writes received later due to the lag between systems should not overwrite new direct data writes, which can be complicated by differences in data store types and data models.

To overcome these challenges and others, a technical solution involving data replication techniques for scalable and consistent data replication and ingestion has been developed. To replicate data from a source system to a target, a data ingestion flow including one or more routers and one or more materializers has been developed. Upon receiving a data write at a source data storage system, data is replicated to a replica data store within the data storage system that replicates data exactly as it appears in the source data store. One or more routers identify updates to objects in the target data model and/or schema based on updates to the replica data store and a mapping between the first schema and the second schema.

In one exemplary embodiment, a computer-implemented method is provided that includes receiving, at a data storage system, a source data write from a source data store. The source data write can be (i) a direct write to the source data store, (ii) a duplicated write from the data storage system, or (iii) a combination thereof. The source data store can be associated with a first schema, and the data storage system can be associated with a second schema that is different from the first schema. The source data write is executed on a replica data store of the data storage system. The replica data store may be associated with the first schema. A transaction is determined based on one or more data operations of the source data write, and a router identifies one or more materializers based on the transaction and a mapping between the first schema and the second schema. The router transmits the transaction to the one or more materializers, and the one or more materializers generate one or more semantic objects and optionally one or more associated watermarks based on the transaction. The one or more semantic objects are transmitted to one or more target data stores of the data storage system, which can be associated with the second schema.

The use of one or more routers and materializers directly addresses the issues of replicating data across systems with differing data models and/or schemas. Each router is configured to understand a mapping between a first schema and/or data model and a second schema and/or data model. Accordingly, router configurations enable the target system to identify impacted data (e.g., impacted semantic objects) corresponding to data changes received from a source system. Additionally, the use of materializers to generate a semantic object (SO) can enable the data storage system to maintain more complex (e.g., semantic) relationships between data by maintaining complex and nested structures of specific data. The materializer can also generate a semantic object that can be converted and indexed according to the various data store types within the data storage system.

Furthermore, the watermarks can be used for resolving race conditions within data replication and data ingestion processes, which directly addresses challenges related to data correctness and consistency in dual write systems. The use of watermarks that are generated based on a source of a data write (e.g., the data write being a direct write, an ingested write, etc.) can enable improved accuracy and data freshness across source and target data systems in multi-master data environments. Additionally, by generating watermarks for ingested writes when data is read from a replica data store within the data system instead of relying on a timestamp associated with the execution on a source data store, the data storage system can ensure data writes can be processed in parallel by routers and materializers without causing stale data overwrites.

As used herein, when an action is “based on” something, this means the action is based at least in part on at least a part of the something.

As used herein, the terms “similarly”, “substantially,” “approximately” and “about” are defined as being largely but not necessarily wholly what is specified (and include wholly what is specified) as understood by one of ordinary skill in the art. In any disclosed embodiment, the term “similarly”, “substantially,” “approximately,” or “about” may be substituted with “within [a percentage] of” what is specified, where the percentage includes 0.1, 1, 5, and 10 percent.

### Overview of Semantic Index

A Semantic Object Model (SOM) can be an effective way of abstracting data to provide a unified view of data that transcends limitations of individual data storage methods, models, schemas, etc. within a data storage system. A semantic object stored within a data system can represent a particular concept and include various attributes associated with the particular semantic object. In some implementations, the semantic object can include self-describing metadata and/or linked actions for custom operations. The semantic object metadata can be used by a model (e.g., a generative model such as an LLM, etc.) to query the model.

Semantic Index (SI) is a data storage system implementing a Semantic Object Model including disparate and varying types of data stores. SI can store data in a custom way spanning multiple storage systems, abstracting from applications and providing a unified, durable, consistent and powerful data store. As a non-limiting example, SI can be used in healthcare environments to improve data accessibility for healthcare professionals and improving patient treatment. Semantic objects within SI can reflect clinical concepts (e.g., patients, treatments, observations, etc.). SI can maintain consistency with a primary source of truth (e.g., an electronic health record (EHR) system of record) to provide patient data related to medical history, diagnoses, etc. Many legacy applications used by healthcare providers rely on prominent platforms supporting conventional EHR systems of record for managing and interfacing with patient and clinical data. For new applications, it can be beneficial to introduce improved semantic techniques to improve access to patient and clinical data. However, for patient records to remain consistent across data platforms and applications, it is important the patient records remain consistent across data models and systems.

In some embodiments, a digital assistant, or chatbot, can interface with the Semantic Index to enable a user to query patient history and data more efficiently. For instance, a digital assistant may be able to query SI using semantic queries generated by a generative model (e.g., a Large Language Model (LLM), etc.). A user may interact with the digital assistant using natural language and then convert the reactions into intelligible queries, such as for clinical questions, etc.

In the interest of clarity of explanation, embodiments of the present disclosure are described in connection with particular data storage systems (e.g., Semantic Index), services (e.g., digital assistants), data models (e.g., Semantic Object Model, relational data models, etc.). However, the embodiments are not limited as such and instead, similarly, and equivalently apply to any data storage system, data models, and services in a multi-data store environment.

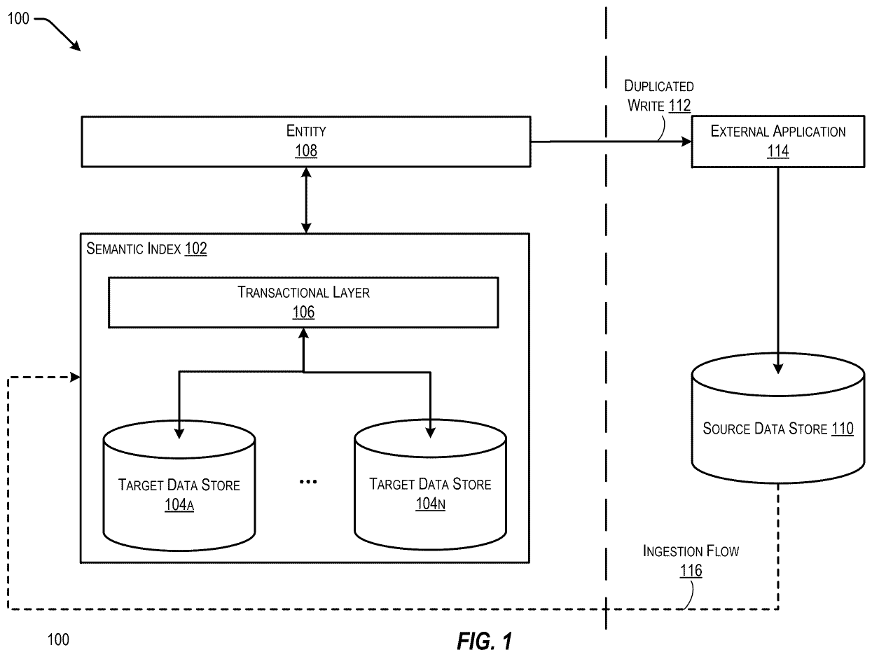

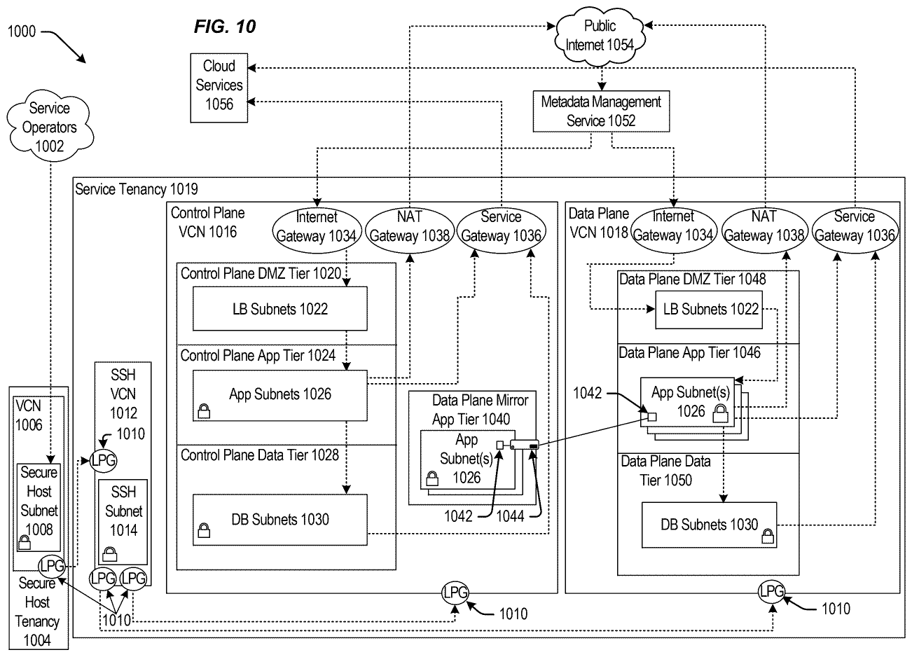

FIG. 1 is a simplified block diagram of an environment 100 of a distributed storage system incorporating Semantic Index. In some instances, the computing environment 100 is part of an Infrastructure as a Service (IaaS) cloud service (as described in more detail with respect to FIGS. 10-14) and semantic index can be implemented as part of the IaaS by leveraging the scalable computing resources and storage capabilities provided by the IaaS provider to process and manage large volumes of data and complex computations. Environment 100 includes Semantic Index (SI) 102 implementing protocols for semantic retrieval of data as described above. While the description of this figure may include various components and processed, it should be understood that additional components, fewer components, or different components as described can be implemented to provide the desired impact.

Semantic Index (SI) 102 can include multiple data stores (e.g., target data store 104a, target data store 104b). In some examples, one or more data stores of target data stores 104a-n are database(s) deployed in a cloud environment using an IaaS cloud service (e.g., as described in more detail with respect to FIGS. 10-14). Each data store within SI 102 may be a different type of data store. For example, target data store 104a can be a vector database (e.g., OpenSearch, Pinecone, etc.) and target data store 104b can be a relational database (e.g., Oracle, MySQL, PostgreSQL, etc.). Additionally or alternatively, Semantic Index 102 can include data stores including, but not limited to, a graph database, NoSQL database, key-value stores, message queues, object stores, etc. Target data stores 104a-n may each contain copies of the same data but provide multiple methods to query and access the data.

While target data stores 104a-n may each be the same and/or different type of data store, each target data store 104a-n may follow the same schema and/or data model. For example, SI 102 can implement the Semantic Object Model as described above, and each target data store 104a-n may implement a schema compatible with the Semantic Object Model. As a particular example, target data store 104b can be a relational database that implements semantic objects as tables within the target data store 104b. Relationships between semantic objects in a relational database may be represented as foreign keys reflecting references to other tables within the target data store 104b.

SI 102 includes a transactional data layer 106 that can process queries to SI 102. The transactional layer 106 can support various types of queries, including, but not limited to QDSL, SQL, ingestion from external sources, etc. Additionally or alternatively, the transactional data layer 106 provides a software development kit (SDK) and/or application programming interface (API) that enables an entity 108 (e.g., a user, application, digital assistant, etc.) to interact with Semantic Index 102. For example, the transactional layer 106 includes an API allowing the entity 108 to read and/or write data to SI. The transactional layer 106 can act as an abstraction of the data stored in SI to the entity 108. For example, the entity 108 can call the API to request access to certain data without having knowledge about specific implementations of data models, schemas, and/or data stores within SI 102. Alternatively or additionally, the entity 108 can query SI using a SQL statement, a vector search, or the like. As such, the entity 108 can query and write to SI based on their own internal data models and/or schemas without understanding specifics about the data storage implementations in SI 102. As a particular example, the entity 108 can be a digital assistant with the capability to receive natural language utterances from a user and determine an execution plan to address In the environment 100 depicted in FIG. 1, writes to SI 102 can occur as a direct write by the entity 108 and/or ingested writes propagated from a source data store 110. The source data store 110 may be a data store externally managed by another organization and/or located in a separate data environment. The source data store 110 may implement a different schema and/or data model than SI 102 and target data stores 104a-n. In some implementations, to maintain consistency between data stored in the target data stores 104a-n and the source data store 110, each direct to SI 102 by the entity 108 may be duplicated to the source data store 110 via a duplicated write 112 provided to an external application 114. The external application 114 may execute the duplicated write 112 on the source data store 110. SI 102 can maintain consistency between the target data stores 104a-n and the source data store 110 via an ingestion flow 116.

Data stored in the source data store 110 may be replicated and concurrently stored in the target data stores 104a-n. In some instances, target data stores 104a-n can include data not stored in the source data store 110. For example, SI 102 may store summaries for semantic objects (e.g., stored within a metadata store in SI) that are not compatible with the schema and/or data model implemented by the source data store 110.

Writes to SI can be writes propagated from SI. For example, the external application 114 may execute a direct write on the source database (e.g., a doctor may use PowerChart to update patient data). In eventually consistent models, writes to the source database should be propagated to the target database and, accordingly, such writes can be ingested by SI 102 through the ingestion flow 116. The ingestion flow 116 can be or can include an event stream, change data capture (CDC) system, replication system, or similar that can capture changes in the source database and replicate the changes in a write to SI.

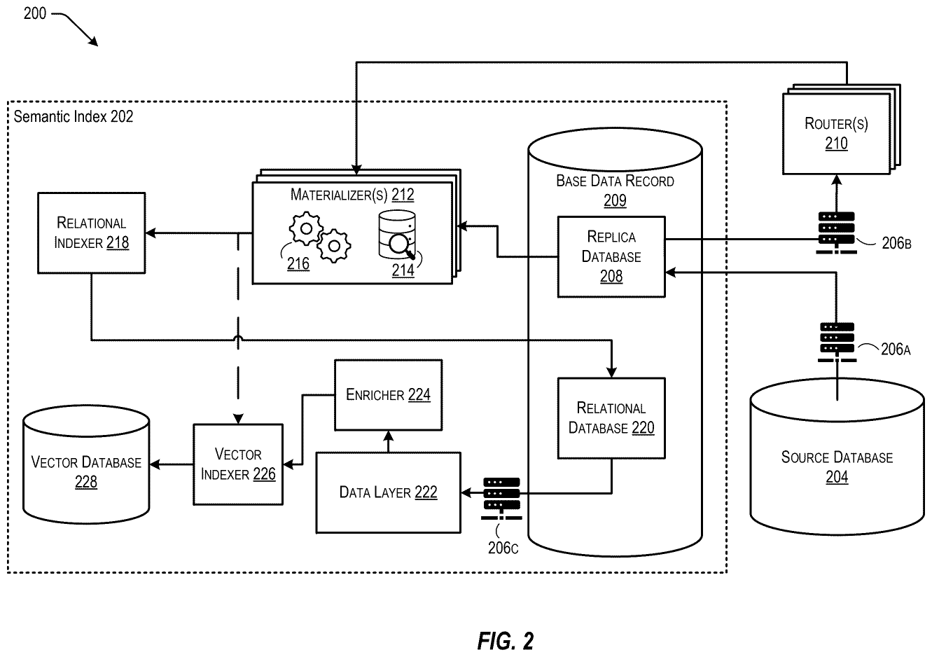

FIG. 2 is an example of an architecture for a computing environment 200 for semantic index implemented with disparate data stores. Certain aspects of FIG. 2 are described with respect to components of the environment described with respect to FIG. 1. As illustrated in FIG. 2, an infrastructure and various services and features can be used to enable the system as described. The following is a detailed walkthrough of an ingestion flow (e.g., ingestion flow 116 of FIG. 1) and the role and responsibility of the components, services, models, and the like of the computing environment 200 within an ingestion flow. In this walkthrough, it is assumed that Semantic Index (SI) 202 is a data storage system that includes data consistent with a source database 204. It is also assumed that any writes to SI 202 are also applied to the source database. In this example, the source database 204 implements a different schema than SI 202 and SI 202 implements a Semantic Object Model.

While the embodiment of computing environment 200 in FIG. 2 illustrates a particular ingestion flow, this is not intended to be limiting and is merely provided to facilitate a better understanding of the role and responsibility of the components, services, models, and the like of the computing environment 200 within the ingestion flow. Some embodiments may include more components than depicted, less components than depicted, or different components than depicted. The ingestion flow, as described, can enable consistent and scalable replication across disparate data stores to enable data synchronization between a source data system and a target data system.

The computing environment 200 includes a source database 204. As described with respect to FIG. 1, the source database 204 can act as a primary source of truth for SI 202. The source database 204 can be a relational database, vector database, NoSQL database, etc. Data stores within semantic index 202 are made consistent with the source database 204. In some implementations, the semantic index 202 includes data not included in the source database 204. As a non-limiting example, the source database 204 is a relational database and acts as an electronic health record (EHR) system of record. The source database 204 may implement a particular schema that is conventionally known.

The source database 204 (e.g., source data store 110 of FIG. 1) can receive a write. For example, a SQL statement may be executed on the source database 204. As described in FIG. 1, the source database can receive the write directly from an external application, or as a duplicated write from a direct write to the Semantic Index 202. By writing the data to the source database, one or more data operations are performed on the source database 204 (e.g., an id is updated, a value is deleted, etc.).

A change data capture (CDC) system 206a (e.g., Kafka, Oracle GoldenGate, Debezium, etc.) may capture data changes in the source database 204 and transmit the data changes to a replica database 208 maintained in semantic index 202. The change data capture system 206a may extract data changes from a transaction log (e.g., redo logs, write-ahead logs, etc.) maintained by the source database 204. The data changes can be transmitted to the replica database 208 as a transaction including one or more data operations (e.g., insertions, deletions, updates, etc.) in the source database 204. In some examples, the data changes can be captured and transmitted as an event stream. The replica database 208 may be a copy of the source database 204 maintained within SI 202 and can serve as the most current known state of the source database 204. The replica database 208 can implement and follow the same schema and/or data model as the source database 204. As such, data changes captured by the CDC system 206a may be executed on the replica database 208 exactly as received. The CDC system 206a can maintain an order of commit of operations executed on the source database 204 and data operations can be executed on the replica database 208 in the order determined by the CDC system 206a.

A second CDC system 206b (e.g., a second Oracle GoldenGate, Debezium, etc.) can capture data changes executed on the replica database 208. The type of CDC system 206b may the same or different as the type of CDC system 206a. The CDC system 206b may extract the data changes from a transaction log maintained by the replica database 208. CDC system 206b packages data changes in the replica database 208 and transmits the data changes to one or more router(s) 210. In some examples, a CDC payload including one or more data operations may be added to a queue associated with the router(s) 210.

The router(s) 210 can be implemented using software only, hardware only, or any combination thereof. The router(s) 210 can be configured to determine semantic objects impacted by data changes in the source database 204 and replica database 208. In some examples, each router 210 may include a mapping of a schema and/or data model implemented by the source database 204 and the schema and/or data model implemented by SI 202. For example, the router(s) 210 may maintain a schema mapping between a table in the source database 204 and semantic objects in SI 202 that consume one or more attributes from the source database 204 table. Accordingly, upon identifying a change to the table in the source database 204, the router(s) 210 may determine the semantic objects impacted by the table update. The router(s) 210 may have a base understanding of attributes and/or fields associated with a particular semantic object. However, each semantic object may include nested structures that the router may be unable to fully and/or accurately map.

The router(s) 210 may not maintain full knowledge of all attributes and nested structures associated with each semantic object in SI 202. For such examples, the router(s) 210 may be configured to identify impacted semantic objects based on table updates, but may not be able to properly construct semantic objects according to the schema implemented by SI 202. The router(s) may invoke one or more materializer(s) 212 to construct the identified impacted semantic objects. The materializer(s) 212 can be implemented with software, hardware, or a combination thereof. Each materializer of the one or more materializer(s) 212 may be configured to construct a particular semantic object. For example, a first materializer may be configured to construct a patient semantic object based on a definition of a patient concept in the semantic model. A second materializer may be configured to construct a treatment semantic object. Upon determining an updated table from the replica database 208 impacts a patient semantic object, the router(s) 210 can invoke the first materializer configured to construct the patient semantic object to generate an updated patient semantic object. The router(s) 210 may invoke multiple materializers by providing each materializer with instructions to construct an updated semantic object. Each materializer of the materializer(s) 212 may construct their respective semantic objects in parallel, sequentially, or any combination thereof.

Each materializer 212 can include a view collector 214 and a finalizer 216. The view collector 214 retrieves current data (e.g., parameters, attributes, data values, etc.) associated with the semantic object based on a known structure of the semantic object. In some examples, the view collector 214 can be a view that presents data from the replica database 208 in a relational and/or JSON format. The finalizer 216 includes software, hardware, or combinations thereof, configured to construct the semantic object using the information retrieved by the view collector 214 from the replica data store. The semantic object can be subsequently written to the relational database 220. The relational data store can follow the SOM, and each semantic object may be stored in a particular table related to the corresponding semantic object. The semantic object is indexed by a relational data store. In some examples, the finalized semantic object generated by the materializer(s) 212 is provided to a relational indexer 218. The relational indexer 218 may optimize data retrieval and may provide a mechanism for writing the semantic object into its relational shape in the relational database 220. In some examples, the relational indexer 218 may provide pointers to particular rows in the relational database 220 to optimize writes to the relational database 220. Accordingly, semantic objects constructed by the materializer(s) 212 can be written to the relational database 220. The replica database 208 and relational database 220 may be hosted in a base data record 209. The base data record 209 may represent the primary source of truth within SI 202, and data stores hosted outside the base data record 209 may maintain consistency with the base data record 209.

A third change data capture system 206c can capture data changes in the relational database 220. For example, data transactions executed on the relational database 220 to write a finalized semantic object can be reflected in a transaction log associated with the relational database 220. Data changes in the relational database 220 may be associated with an updated semantic object. The CDC system 206c may extract change data from the transaction log associated with relational database 220. The change data can be transmitted to a data layer 222. The data layer 222 may mirror a read-write interface provided by an SDK associated with SI 202 and may orchestrate read-write requests to involve processes such as authorization, persistence, versioning, and event management. In some examples, the data layer 222 may execute processes such as versioning and event management asynchronously.

The change data (e.g., updated semantic object(s) and/or updates associated with one or more semantic object(s)) can be processed by an enricher 224 configured to add context to the data and prepare the data to be stored in the vector database 228. Semantic object data determined from the change data can be vectorized and provided to a vector indexer 226. The vector indexer 226 can provide a mechanism for writing a semantic object in its vectorized shape into the vector database 228. In some examples, the semantic object may be stored as one or more embeddings (e.g., numerical vector representations) to capture semantic meaning and relationships across semantic objects.

While the ingestion flow depicted in FIG. 2 depicts a data write executing on the relational database 220 store prior to being converted and indexed to be written to the vector database 228, the finalized semantic object generated by the materializer(s) 212 directly to the vector indexer 226 to be written to the vector database 228. In such ingestion flows, each semantic object may be written in parallel to the relational database 220 and the vector database 228.

### Scalable Replication Across Disparate Data Store and Models

As described above, consistent and scalable replication across data models can be challenging in data environments with disparate data stores implementing varying data models and/or schemas. In such environments, conventional techniques for data replication involving copying data to a replica store can be inadequate to accurately replicate data from a first data model and/or schema to a second data model and/or schema. Furthermore, data environments such as SI can include various types of data stores (e.g., a vector database, relational database, etc.) and each replicating data to the various data stores. To enable replication across disparate data stores and models in heterogeneous data environments, components of an ingestion flow (e.g., router(s), materializer(s)) can be configured to understand a mapping of data from a source data model to a target data model.

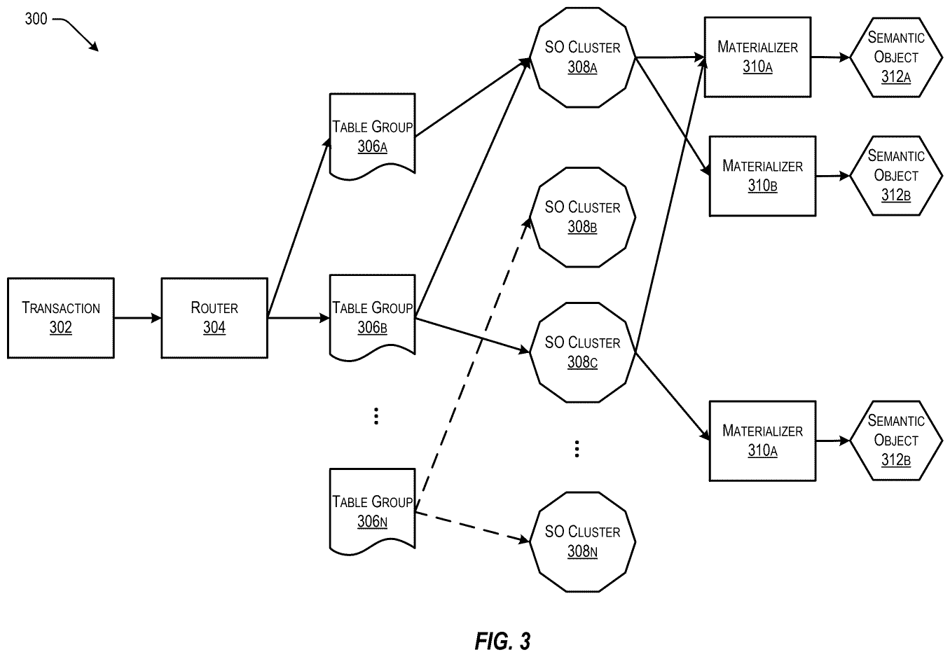

FIG. 3 depicts an exemplary data flow 300 for mapping a transaction including data changes from a first schema to a second schema, according to various embodiments. While the data flow 300 illustrates various components and implementations for concepts in a Semantic Object Model, this is not meant to be limiting and a similar data flow can be applied to various other data models and schemas.

A router 304 (e.g., router(s) 210 of FIG. 2) receives a transaction 302 containing data changes in a source data store (e.g., source database 204 of FIG. 2). The transaction 302 can include data changes caused by the execution of one or more data writes. The router 304 may receive the transaction 302 from a CDC system (e.g., CDC system 206b of FIG. 2) that extracts data changes from a replica data store (e.g., replica database 208 of FIG. 2). In some examples, the transaction 302 may be extracted from a transaction log associated with the replica data store. The replica data store can include a copy of data stored in a source data store (e.g., source database 204 of FIG. 2). In some implementations, the router 304 can receive the transaction 302 from a CDC system that extracts data changes directly from the source data store. The transaction 302 includes one or more data operations (e.g., insertions, deletions, updates, etc.) reflecting changes committed to the source data store. The data operations included in the transaction 302 can be row-level changes from the source database. Additionally or alternatively, the transaction 302 can include relevant information (e.g., metadata) for each data operation including but not limited to an operation type, a timestamp corresponding to the transaction 302 and/or a data operation, and the table upon with the data operation was committed.

The router 304 accesses a router configuration (e.g., a configuration file, environment variable, router settings, etc.) that specifies a mapping between the source schema and target schema. The router configuration may include a predetermined schema and/or data model mapping between the source and target systems. The router configuration corresponds to a mapping of table groups of a source database (e.g., source database 204 of FIG. 2) to semantic object (SO) clusters of SI (e.g., the target system). In some examples, a component of SI (e.g., the router 304 and/or an alternative component) may dynamically determine mappings between the source schema and the target schema based on historical transactions. For example, the router 304 may determine changes to data in a certain table impact a particular semantic object with a particular frequency and accordingly generate a mapping between the table and the semantic object.

Table groups 306a-306n can each represent groups of one or more tables that reflect a concept within the source schema. For example, table group 306a may represent a Patient concept in the first schema and can include tables such as Person_Name, Person_Alias, Phone, Address, Person_Personal_Relation, Condition_Name, etc. In some examples, table groups 306a-n may be explicitly defined as concepts and/or groups within the source schema. Additionally or alternatively, table groups 306a-n may be defined as concepts and/or groups by the router configuration used to accessed by the router 304.

Each table group 305a-n corresponds to one or more semantic object (SO) clusters 308a-n. Each SO cluster 308a-n represents a set of SOs in SI that are impacted by changes executed on the tables included in a respective table group. Mappings between table groups and SO clusters can be one-to-one mapping, one-to-many mappings, many-to-one mappings, many-to-many mappings, or combinations thereof. For example, table group 306b may be group of tables representing a patient concept within the first schema. SO clusters 308a and 308c may each include one or more semantic objects that store information corresponding to a patient concept. For example, SO cluster 308a may include semantic objects related to patient information and SO cluster 308c may include semantic object related to treatment information. Accordingly, changes to tables within the table group 306a may impact semantic objects within SO clusters 308a and 308c and the router configuration may define a mapping from table group 306a to SO clusters 308a and 308c. For example, the router 304 may identify that a table (e.g., condition_name) within table group 306a was updated by the transaction 302. Subsequent to identifying one or more table groups updated by the transaction, the router 304 identifies appropriate SO clusters that consume updates to the table.

In some examples, a semantic object may be included in multiple SO clusters. As an alternative example, semantic object 312a may represent a condition semantic object. The condition semantic object may include information related to a problem (e.g., symptoms) and a diagnosis. Table group 306a may include data related to a problem concept (e.g., problem_action, problem_discipline, etc.) and table group 306b may include data related to a diagnosis (e.g., diagnosis_group, diagnosis_action, etc.). Accordingly, semantic object 312a may consume updates from both table group 306a and table group 306b and may be included in SO clusters 308a and 308c.

In some examples, a semantic object within an SO cluster may not directly consume information stored with a table within a corresponding table group, but a mapping may still exist between the table group and the SO clusters. Such semantic objects may include nested structures, where an update to a table in the first schema can impact a nested structure within the semantic object. For example, a semantic object within SO cluster 308c may not include an attribute for diagnosis information. However, the semantic object may include a relationship between a patient semantic object and a condition semantic object, and may accordingly be impacted by updates to diagnosis data in the source system.

As another example, changes to tables within table group 306b may map to SO cluster 308a and change to tables within table group 306n may map to SO clusters 308b and 308n. The transaction 302 may include changes to tables within table groups 306a and table group 306b and, accordingly, the transaction 302 may impact semantic objects within SO cluster 308a and 308c.

Each semantic object within an SO cluster corresponds to a materializer configured to generate each respective semantic object. For example, an SO cluster can include an SO that maps to materializer 320a and a second sematic object that maps to materializer 320b. Each semantic object, however, may include information that is not directly related to a table update. For example, the semantic object can include a nested structure that includes one more foreign key relationships between tables. As a particular example, relevant values consumed by the SO from the source system may be represented by a snowflake schema that includes a main table (e.g., a fact table) and multiple related tables containing attributes associated with the SO. The materializer may access the snowflake schema to retrieve relevant values from a replica data store and generate the semantic object. Additionally or alternatively relevant values consumed by a semantic object can be represented by a star schema that includes a main table and one or more tables containing relevant values associated with attributes of the semantic object. A materializer configured to generate the semantic object may access the star schema associated with the SO to retrieve the relevant values and generate the semantic object.

Each materializer reconstructs the entire semantic object based on data retrieved from a replica data store. For example, if a patient semantic object includes data across various tables, the materializer retrieves the relevant values from the replica data store.

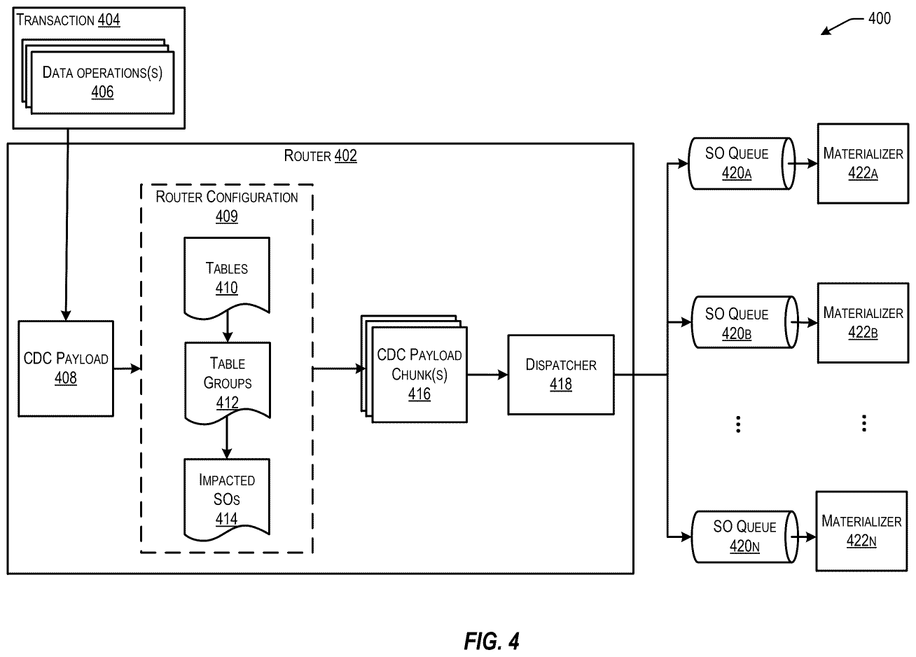

FIG. 4 depicts an exemplary routing subsystem 400 including a router and materializer for transforming data operation ingested from a source data store to a target data store, according to various embodiments. The routing subsystem 400 includes a router 402 (e.g., router(s) 210 of FIG. 2) implemented in software, hardware, or combinations thereof for receiving one or more data operations reflecting changes in a source data store and determining relevant semantic objects to be updated in a target data system. The routing subsystem 400 further includes materializers 422a-n (e.g., materializer(s) 212 of FIG. 2) configured to execute one or more processes and/or programs using software, hardware, or combinations thereof, to generate semantic objects.

As depicted in FIG. 4, the router 402 receives a transaction 404 corresponding to one or more data operation(s) 406. In some examples, the data operation(s) can be extracted by a CDC system (e.g., CDC system 206b of FIG. 2). Each data operation can include changes (e.g., insertions, deletions, updates, etc.) to data within the source data store. In some examples (e.g., as described with respect to FIG. 2), the changes provided to the router 402 based on changes executed on a replica data store (e.g., replica database 208 of FIG. 2).

The router 402 processes a single transaction 404 to preserve the commit order of data operation(s) 406 within the transaction. One or more additional routers may process additional transactions in parallel, in sequence, or combinations thereof, with respect to router 402. The transaction 404 can include operation data and temporal data for one or more data operation(s) 406 associated with the transaction. The operation data can indicate an operation type (e.g., op_type) using transaction semantics (I (Insert) or U (update) or D (Delete)) and the temporal data can be a transaction and/or data operation timestamp. In some examples, the operation data can include one or more images of data impacted by a data operation 406 including, but not limited to, a before image of data changed by a transaction and/or an after image of data change by a transaction.

The router 402 can generate a CDC payload 408 including relevant information (e.g., operation data, metadata) from the data operation(s) 406 that can be utilized by the materializers 422a-n to generate the respective semantic objects. The CDC payload 408 is transmitted to and processed by one or more relevant materializers 422a-n to generate semantic objects impacted by the data operation(s) 406. Accordingly, the CDC payload 408 includes relevant information (e.g., metadata, data operation changes) that can be used by the materializers 422a-n to generate the correct semantic object. The CDC payload 408 can include a descriptor of the transaction and/or metadata of the data operation(s) 406 in the transaction 404. The CDC payload 408 can include transaction information including but not limited to table name(s), data operation type(s), transaction and/or data operation timestamp(s), and transaction ID. Based on the operation data associated with the data operation(s) 406, the router 402 may determine relevant primary keys, foreign keys, or combinations thereof, impacted by the data changes. For example, the transaction 404 may include a data operation 406 corresponding to an update to a particular value in a ‘patient’ table. The router 402 may determine whether the updated value corresponds to a foreign key reflected in an additional table within the schema of the primary store. Accordingly, the CDC payload 408 can include primary table column names, values for primary keys of the table impacted by the data changes, a target table (e.g., primary key) referenced by the foreign key, target table column, a target table column value impacted by the data changes, or combinations thereof.

Based on the generated CDC payload 408, the router 402 determines any semantic objects impacted by the changes reflected in the CDC payload 408. The router 402 can access a router configuration 409 (e.g., a configuration file, environment variables, etc.) that specifies a mapping between tables of the source data store and semantic objects of the target data store.

The router may implement the data flow 300 described with respect to FIG. 3 to determine relevant table groups 412 and impacted semantic objects (SOs) 414. For example, the router configuration 409 can include a mapping of table groups 412 and SO clusters. The router 402 can determine the set of tables 410 with data changes based on the transaction descriptor, transaction metadata, and/or change data operation information included in the transaction 404 and/or CDC payload 408. Based on the schema mapping defined by the router configuration 409, the router 402 determines table groups 412 corresponding to the tables 410 and identifies SO clusters that consume information from the table groups 412.

In some examples, the router 402 divides the CDC payload 408 into one or more CDC payload chunk(s) 416 according to the identified impacted SOs 414. Each CDC payload chunk 416 can include a subset of logically exclusive data operations based on the impacted SO. Logically exclusive data operations can include sets of data operations that impact different records (e.g., SOs) and can be applied independently and/or in parallel. For example, the router 402 may identify that a subset of data operations 406 reflected in the CDC payload 408 impact a first semantic object, while a second subset of data operations 406 reflected in the CDC payload 408 impact a second semantic object. The router 402 may generate a first CDC payload chunk 416 that includes operation data corresponding to data operations impacting the first semantic object and a second CDC payload chunk that includes operation data for data operations impacting the second semantic object. Each CDC payload chunk 416 can be provided to the corresponding materializers 422a-n to for processing and semantic object generation. As such, a materializer 422a corresponding to the first semantic object may be provided with the first CDC payload chunk and may not be provided with the second CDC payload chunk. Similarly, a second materializer 422b corresponding to the second semantic object may be provided with the second CDC payload chunk and may not be provided with the first CDC payload chunk.

Dividing the CDC payload 408 into CDC payload chunks 416 can increase parallelism within the system by enabling multiple materializers to process data changes and generate semantic objects in parallel. Furthermore, the amount of processing performed by each materializer 422a-b may be reduced due to the reduced number of data operations and associated operation data included within each CDC payload chunk 416. In some examples, each CDC payload chunk 416 may maintain the same structure as an undivided CDC payload 408.

The router 402 can include a dispatcher 418 configured to transmit a CDC payload 408 and/or CDC payload chunk 416 to an appropriate SO queue 420a-n corresponding to materializer 422a-n for the impacted SOs 414. The dispatcher 418 may access a dispatcher configuration (e.g., a configuration file, environment variables, system settings, etc.) to determine mappings of impacted SOs 414 to relevant SO queues 420a-420n. For example, if the impacted SOs 414 include an SO configured to be generated by materializer 422a, the dispatcher 418 may append a CDC payload chunk 416 corresponding to the SO to SO queue 420a. In some implementations, SO queues 420a-n can be message queues (e.g., a Kafka queues) that implement a publisher-subscriber models (e.g., where the relevant materializer of the materializers 422a-n acts as a subscriber of the queue). For example, each materializer 422a-n may subscribe to a topic corresponding to the particular semantic object the materializer is configured to generate.

In some examples, the router 402 may transmit the CDC payload 408 to the dispatcher 418 in addition to or alternative to dividing the CDC payload 408 and transmitting CDC payload chunk(s) 416 to the dispatcher 418. For example, the router 402 may determine all data operations 406 associated with the CDC payload 408 impact the same SOs and thus cannot be divided into logically exclusive chunks. In some implementations, the router 402 may not divide the CDC payload 408 into chunks and the dispatcher 418 may append the CDC payload 408 to SO queues for each impacted SO in the set of impacted SOs 414.

Each materializer 422a-n identifies, from the CDC payload 408, one or more primary keys of rows changed in the source database. Each materializer receives, as a part of the CDC payload 408, one or more primary keys and/or foreign keys associated with data changes in the source database. Based on a specific SO schema (e.g., attributes associated with the SO represented as a star schema, snowflake schema, etc.) the materializer retrieves relevant values consumed by the SO as attributes and/or metadata from a replica data store and generates the SO using the retrieved values.

In some instances, some semantic objects may be updated more frequently than others. Accordingly, semantic objects associated with frequent updates may be associated with multiple materializers. In such instances, an SO queue for a particular SO may correspond to multiple materializers that can each retrieve CDC payloads 408 and/or CDC payload chunk(s) 416 from the SO queue.

### Watermarks for Consistent Replication and Resolving Race Conditions

As described above, preventing stale data overwriting is a particular challenge in maintaining consistent replication across disparate and distributed data systems. For example, with respect to the Semantic Index, multiple routers and materializers are implemented to decrease ingestion latency and lag between the source data store and target data store by increasing parallelization of data replication. However, if two data writes are executed on the same data in a source data system, parallelizing downstream data writes can introduce potential stale data overwriting if a data write executed first in a source data system is executed subsequently on a target data system. Furthermore, multi-master configurations (e.g., where source data stores and target data stores may both receive direct writes) can introduce additional sources of data overwrites and inconsistencies. The lag between receiving data write at a source data system and executing the data write on target data stores of SI can be significantly more than the delay between receiving a direct data write at SI and executing the direct data write within target data stores of SI. To address these issues, techniques for watermark generation and evaluation with awareness of the source of data writes (e.g., direct writes, ingested writes, etc.) are implemented by SI to preserve data synchronization between source and target systems, and to prevent inaccurate and stale data overwriting.

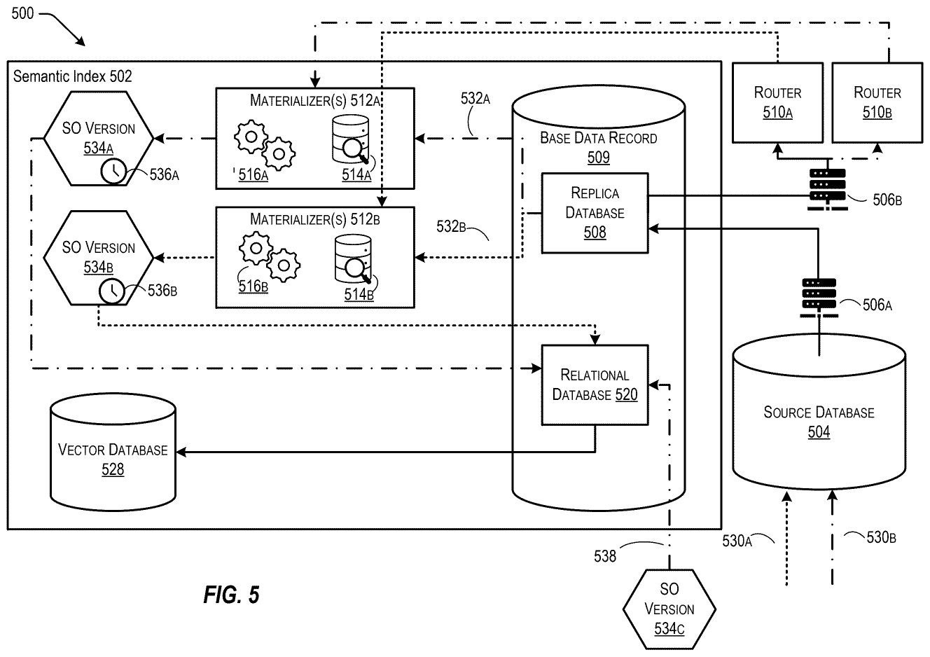

FIG. 5 depicts an ingestion flow 500 implementing watermark generation for replicating multiple data writes from a source system to a target system, in accordance with various embodiments. Certain aspects of FIG. 5 are described with respect to components of the computing environments described with respect to FIG. 2. While the ingestion flow 500 describes watermark generation with respect to writes to the relational database 520 within SI 502, the ingestion flow 500 can include watermark generation for additional target stores within SI 502 such as vector database 528 or any additional target data store not depicted in FIG. 5.

Each target data store of SI 502 may maintain distinct sets of watermarks. Additionally or alternatively, source database 504 or other similar source systems may include similar and/or different implementations of watermarking.

At the semantic object level, watermarks can be stored as attributes and/or metadata of a sematic object (e.g., as a timestamp, etc.). A watermark can indicate the freshness of the semantic object and a time up to which the data can be considered accurate. Watermark generation may vary depending on the source of the data write within the data system.

For data writes ingested by SI 502 from a source data system (e.g., source database 504), watermarks can be determined by a materializer configured to generate a particular semantic object. As an example, a source data write 530a is executed on the source database 504. As described with respect to FIG. 2, the source data write 530a is extracted by a CDC system 506a (e.g., CDC system 206a of FIG. 2) and executed on the replica database 508 (e.g., replica database 208 of FIG. 2). The source data write 530a is then processed by a CDC system 506b (e.g., CDC system 206b of FIG. 2) and provided to a router 510a (e.g., router(s) 210 of FIG. 2), which routes the transaction to a relevant materializer 512a (e.g., materializer(s) 212 of FIG. 2) that can generate an SO version 534a. As used herein, a version of a semantic object can be an instance, data record, etc. of a semantic object that can be stored in a data store (e.g., as generated by a materializer).

The materializer 512a generates the SO version 534a by executing one or more data read(s) 532a on the replica database 508 to retrieve current state information of attributes of the identified semantic object (e.g., as described with respect to FIGS. 2-4). The materializer 512a can determine a watermark 536a associated with the SO version 534a based on a time at which the one or more data reads 532a were executed. In some examples, the one or more data reads 532a are initiated and/or executed by a view collector 514a (e.g., view collector 214 of FIG. 2) configured to retrieve a current state of data relevant to the semantic object. In some examples (e.g., when the replica database 508 implements a relational data model and/or schema), the view collector 514a may be initialized with one or more predefined SQL queries for creating a view (e.g., virtual table) of the relevant data consumed by the semantic object. The one or more predefined SQL queries for generating a view including data relevant to a particular semantic object can be executed by the view collector 514a, causing one or more data reads 532a to be performed. The watermark 536a can be or can include a timestamp corresponding to the time at which the data read(s) 532a were executed. The timestamp may be based on a time determined by a time determining mechanism of the replica database 508 and/or SI 502. For example, the timestamp may be determined by using a wall clock, logical clock, physical clock, etc. As such, the watermark 536a can reflect the freshness of the data up to the point at which it was read by the materializer 512a.

In some instances, the source database 504 may receive a second source data write 530b that can impact the same semantic object as the source data write 530a. The second source data write 530b may impact the same data within the source database 504 as the first source data write 530a and/or different data within the source database 504. For example, an impacted SO may consume information from a group of tables within the source database 504. The first source data write 530a may update one or more values in a first table within the group of tables. The second source data write 530b may update one or more values in the first table or in a second table within the group of tables. Because the impacted semantic object consumes one or more values from both the first table and the second table, the materializer(s) generate versions of the same semantic object upon receiving the data changes.

Once written to the replica database 508, the first source data write 530a and second source data write 530b may be processed in parallel according to the ingestion flow. For example, a transaction associated with the first source data write 530a may be provided to router 510a by the CDC system 506b and a transaction associated with the second source data write 530b may be provided to a second router 510b. The routers 510a-b may process the respective data writes (e.g., as described with respect to FIGS. 3-4) in sequence, in parallel, or combinations thereof. In some instances, router 510b may finish processing and routing a transaction corresponding to the second source data write 530b before router 510a finishes processing and routing a transaction corresponding to the first source data write 530a despite the first source data write 530a executing on the source database 504 before the second source data write 530b.

Additionally or alternatively, SI 502 may include multiple materializers 512a-512b configured to generate the same semantic object. In some examples, the semantic object generated by the materializers 512a-b may be a semantic object that is identified as receiving frequent updates in the source database 504. The materializers 512a-b may process CDC payloads corresponding to the source data writes in parallel, in sequence, or combinations thereof. Furthermore, the materializer 512a-b may finish processing the payloads in the same order and/or a different order as the processing performed by the routers 510a-b. For example, router 510a may transmit CDC payload(s) to materializer 512a before router 510b transmits CDC payload(s) to materializer 512b, but materializer 512b may generate SO version 534b before materializer 512a generates SO version 534a.

Watermarks determined by the materializers can resolve staleness issues described above. Each materializer 512a-b generates the respective SO versions 534a-b using information retrieved from replica database 508 from data reads 532a-b. The information retrieved from the replica database 508 can include relevant values for each attribute of the semantic object regardless of whether the value was updated by any particular source data write. As such, the SO versions 534a-b include information about the respective SO from the replica database 508 that is accurate up to the time of the read and can include changes from writes committed after the respective source data writes 530a-b. For example, a third source data write may be executed on the replica database 508 while transactions corresponding to source data writes 530a-b are processed by routers 510a-b and/or before materializers 512a-b retrieve relevant information from the replica database 508 via data reads 532a-b.

The watermarks 536a-b can accordingly reflect the freshness of the semantic object according to the replica database 508 regardless of commit order in the source database 504. For example, the watermark 536b for SO version 534b indicates the SO version is accurate with respect to the source database 504 as of the timestamp reflected by the watermark 536b. The watermark 536a for SO version 534a indicates the SO version is accurate with respect to the source database 504 as of a timestamp reflected by the watermark 536a. SO versions 534a-b can be written to relational database 520 based on a comparison of the watermarks 536a-b and the watermark of the SO as stored in the relational database 520.

Additionally or alternatively, SI 502 can receive a direct data write 538 including changes to a semantic object within a database. The direct data write 538 can be associated with an SO version 534c that may include the same and/or different data as SO versions 534a-b and can result in a stale overwrite depending on commit orders to the source database 504 and to SI 502. SI 502 can generate a placeholder watermark for the SO version 534c corresponding to the direct data write 538. The placeholder watermark may be calculated as a current timestamp incremented by a single unit of time. For example, if the smallest unit of time tracked by SI 502 is a nanosecond, the watermark for SO version 534c may be calculated as the current time incremented by a nanosecond. The SO version 534c can then be written to the relational database 520 according to watermark evaluation of the semantic object version currently stored in the relational database 520. For example, SI 502 can perform a comparison between the watermark of the semantic object as stored in the relational database 520 and the placeholder watermark determined for SO version 534c to determine whether the SO version 534c is associated with fresh data that can safely be written to the relational database 520.

Because SI 502 maintains consistency with the source database 504, one or more duplicated source data write including information associated with SO version 534c can be executed on the source database 504. For example, upon receiving direct data write 538, a duplicated source data write can be generated and executed on the source database 504. The duplicated source data write can be ingested and generated as described with respect to SO versions 534a-b.

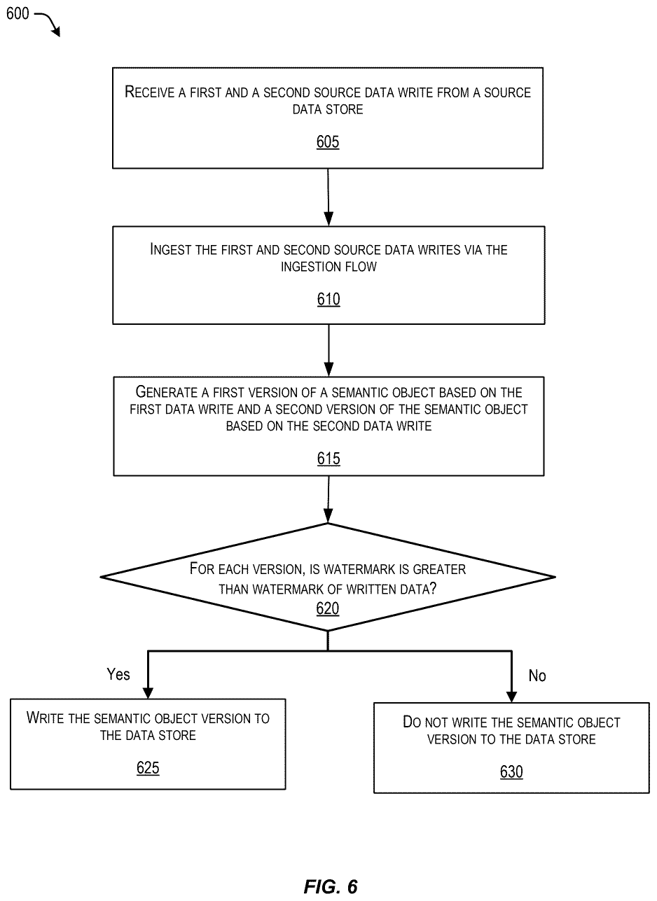

FIG. 6 is a flowchart depicting a flow 600 implementing watermark generation and evaluation for resolving a first race condition when receiving writes at a source and target store, in accordance with various embodiments. As described in the flow 600, a race condition can occur in instances where a source system (e.g., source database 204 of FIG. 2, source database 504 of FIG. 5) receives multiple data writes directed towards the same data in a target system (e.g., updating the same semantic object in the target data system). The first race condition as described with respect to flow 600 can occur when multiple writes are received at a source data system (e.g., at source database 504 of FIG. 5) and subsequently ingested to a target data system (e.g., SI 502 of FIG. 5).

At step 605, the source data store (e.g., source database 504 of FIG. 5) receives a first source data write (e.g., source data write 530a of FIG. 5) and a second source data write (e.g., source data write 530b of FIG. 5). The source writes may be direct writes to the source data store, duplicated writes from the target system, or combinations thereof. For example, both the first write and the second write may be direct writes to the source data system. As another example, the first data write may be a direct data write to the source system and the second data write may be a duplicated write including data changes first executed on the target data system. The first source data write and the second source data write may impact the same and/or different data stored in the source data system. For example, both data writes may update different data within the source system that map to the same semantic object within the target system. As described with respect to FIG. 3, the first source data write and second source data write may impact different tables in the source data store within a table group that impacts a particular semantic object. For illustrative purposes, the first source data write may be executed on the source data store before the second source data write is executed on the source data store. Each data write may correspond to the same semantic object(s) within Semantic Index (e.g., SI 502).

At step 610 of the flow, the data writes are ingested through an ingestion flow (e.g., as described with respect to FIG. 2). For example, as described with respect to FIGS. 2-5, the data writes can be processed by a CDC system (e.g., CDC system 506a of FIG. 5) that replicates data changes to a replica data store (e.g., replica database 508 of FIG. 5). Data changes in the replica data store can be captured and replicated by a second CDC system (e.g., CDC system 506b of FIG. 5) and provide transactions to one or more routers (e.g., routers 510a-b of FIG. 5). The routers route the transactions to one or more relevant materializer(s) (e.g., materializers 512a-b of FIG. 5).

At step 615, the materializer(s) generate a first version of the semantic object (e.g., SO version 534a of FIG. 5) according to a CDC payload corresponding to the first data write and a second version of the semantic object (SO version 534b of FIG. 5) according to a CDC payload corresponding to the second data write. The materializer(s) retrieve one or more relevant values consumed by the semantic object (e.g., via data reads 532a-532b). The first and second versions of the semantic object may be generated in parallel, in sequence, or combinations thereof. For example, the data storage system may include multiple materializers configured to generate the semantic object and each materializer may generate the respective semantic objects in parallel. In some examples, the data storage system may include a single materializer for the semantic object and each data write may be generated in the order they are routed to the materializer.

Each version (e.g., instance, record, etc.) of the semantic object is associated with a watermark (e.g., watermarks 536a-b of FIG. 5) generated based on a timestamp at which the materializer reads data from the replica data store. The watermark may be an attribute of the semantic object and/or stored as metadata of the semantic object.

At block 620, the data system and/or data store determines, for each SO version, whether the watermark is greater than the watermark of the written data. In some examples, the materializer(s) may finish processing and generating the second version of the semantic object corresponding to the second data write before the first version corresponding to the first data write. However, because the materializer(s) reconstructs the semantic object and reads all attributes included in the semantic object from the replica data store to generate the semantic object version, the first version may contain a more recent read of the data as indicated by the watermark associated with the semantic object.

The semantic object (e.g., the written data) stored in the data store includes a watermark generated during a previous ingestion and/or receipt of a data write. Determining if the watermark of the semantic object version is greater than the watermark of the stored semantic object can include determining if the watermark of the semantic object version reflects a more recent timestamp (i.e., the watermark of the written data is an earlier time).

At block 625, if the watermark is greater than the watermark of the written data, the semantic object version is written to the data store. As an example, the first SO version may be processed and generated by the materializer(s) before the second SO version and the first SO version may have a watermark reflecting a time earlier than the watermark of the second SO version. The watermark of the first SO version may be determined to be greater than the watermark of the stored SO and the first SO version may be written to the data store. The second SO version is determined to have a watermark greater than the first SO version, and the second SO version may also be written to the data store.

As another example, the second SO version may be processed and generated by the materializer(s) before the first SO version and the second SO version may have a watermark reflecting a time earlier than the watermark of the first SO version. The watermark of the second SO version may be determined to be greater than the watermark of the stored SO and the second SO version may be written to the data store. Subsequently, the watermark of the first SO version may be determined to be greater than the watermark of the SO version and the first SO version can be written to the data store.

At block 630, if the watermark is not determined to be greater than the watermark of the written data, the semantic object version is not written to the data store. As an example, the first SO version may be generated and processed by the materializer(s) before the second SO version, but the data reads used to retrieve data for the second SO version may have been executed before the data reads used to retrieve data for the first SO version. In such instances, the watermark of the first SO version can be greater (i.e., reflecting a more recent time) than the watermark of the second SO version. The watermark of the first SO version may be greater than the watermark of the stored SO and the first SO version may be written to the data store.

However, the watermark of the second SO version is not greater than the watermark of the first SO version and, as such, the second SO version is not written to the data store.

In some examples, the source data writes may have an insert operation type. In such examples, the SO version that is written second may be discarded if both SO versions contain duplicated data.

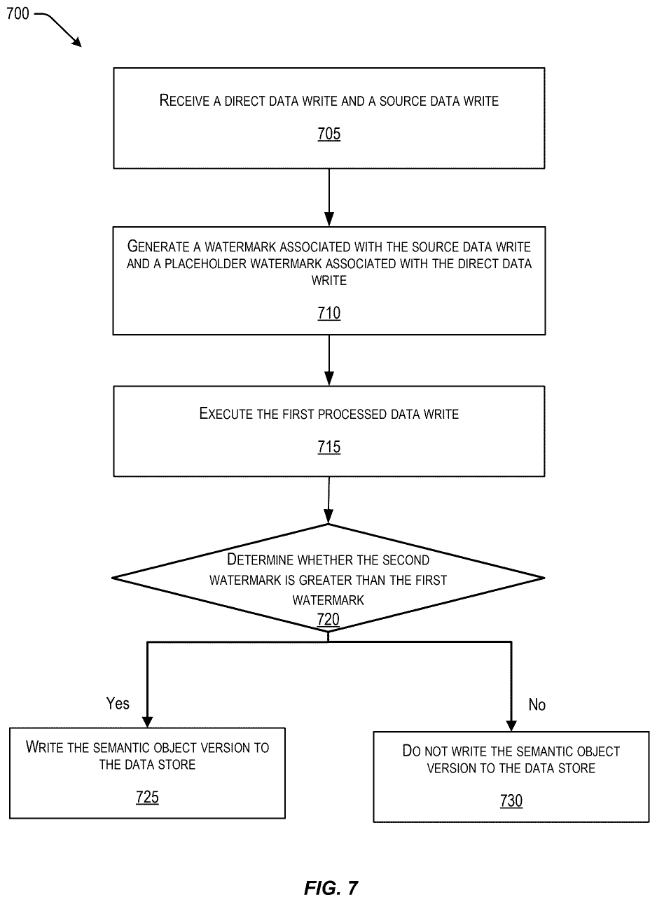

FIG. 7 is a flow depicting a flow 700 implementing watermark generating and evaluation for resolving a second race condition when receiving writes at a source and target store, in accordance with various embodiments. As described in flow 700, a race condition can occur in instances where a source system (e.g., source database 204 of FIG. 2, source database 504 of FIG. 5) receives a data write directed towards a semantic object in the target data system and the target system (e.g., SI 202 of FIG. 2, SI 502 of FIG. 5) receives a direct write to the same semantic object.

At block 705, the source data store (e.g., source database 504 of FIG. 5) receives a source data write (e.g., source data write 530a of FIG. 5) and the target data system (e.g., SI 502 of FIG. 5) receives a direct data write (e.g., direct data write 538 of FIG. 5). The source data write may be direct writes to the source data store, duplicated writes from the target system, or combinations thereof. The target data system receives the source data write through an ingestion flow (e.g., as described with respect to FIG. 2). In some examples, the source data write received by the source data store is a duplicated data write corresponding to the direct data write received by the target data system. Each data write is associated with updates to the same semantic object(s) within the target data system (e.g., SI 502).

At block 710, a watermark associated with the source data write and a watermark associated with the direct data write are generated. The watermark (e.g., watermark 536a of FIG. 5) associated with source data write is generated by a materializer (e.g., materializer 512a of FIG. 5) based on a timestamp associated with data read(s) (e.g., data read(s) 532a of FIG. 5) used to generate a source SO version (e.g., SO version 534a of FIG. 5). The placeholder watermark associated with the direct data write of an SO version (e.g., SO version 534c of FIG. 5) is determined by the target data system by incrementing the current time by a single time unit (e.g., a nanosecond, millisecond, second, etc.).

At block 715, the first processed write is executed. A processed data write can be a data write for which an SO version with an associated watermark has been generated and is ready to be executed. In examples where the source data write is a duplicated data write of the direct data write, the first processed write is often the direct data write due to lag associated with the ingestion flow from the source data store and the target system. A comparison is performed between the watermark of the first processed write (e.g., as described with respect to FIGS. 5-6) to determine whether the watermark is greater than the watermark of the stored data in the target system and/or target data store (e.g., a stored SO). For example, if the source data write is processed first, the source SO version is written if the watermark associated with the source SO version is determined to be greater than the watermark of the stored SO. If the direct data write is processed first, the direct SO version is written to the data store if the placeholder watermark is greater than the watermark of the stored SO. Because the placeholder watermark is set to the most current time, the SO version corresponding to the direct data write (e.g., SO version 534c of FIG. 5) may be successfully executed assuming no other data write has executed and updated the stored watermark.

At block 720, the target system determines whether the watermark of the second processed write is greater than the watermark of the first processed and executed data write. For example, if the direct data write is successfully executed first and no intermediate data write has been executed on the data store, the target system determines whether the watermark associated with the source SO version is greater than the placeholder watermark of the direct data write. If the source data write is successfully processed and executed first and no intermediate data write has been executed on the data store, the target system determines whether the placeholder watermark of the direct data write is greater than the watermark of the source SO version. In some examples, a data write may be executed after the first executed write at block 715 and before the second write of the writes received at block 705. In such examples, the data system may perform a comparison of a watermark of the update SO stored in the data store and the watermark associated with the second processed data write.

At block 725, the SO version corresponding to the second processed data write is written to the data store if the second watermark (i.e., the watermark associated with the second processed data write) is determined to be greater than the first watermark (i.e., the watermark associated with eh first processed data write).

At block 730, the SO version corresponding to the second processed data write is not written to the data store if the second watermark is determined not to be greater than the first watermark.

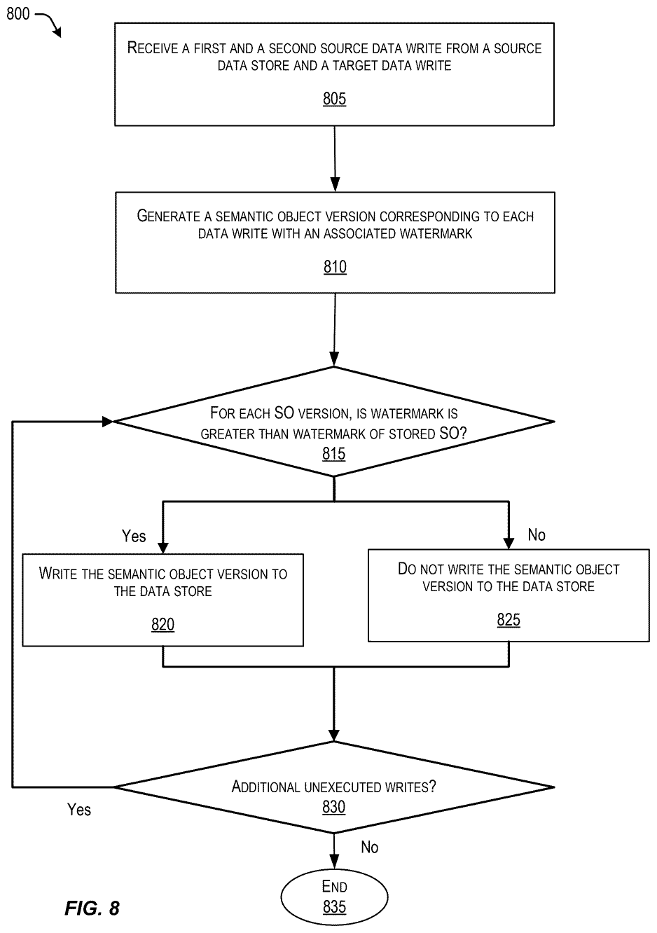

FIG. 8 is a flowchart depicting a flow 800 implementing watermark generation and evaluation for resolving a third race condition when receiving writes at a source and target store, in accordance with various embodiments. As described in the flow 800, a race condition can occur in instances where a source system (e.g., source database 204 of FIG. 2, source database 504 of FIG. 5) receives multiple data writes directed towards the same data in a target system (e.g., SI 502 of FIG. 5) and the target system also receives a direct write directed towards the same data.

At block 805, the source data store (e.g., source database 504 of FIG. 5) receives a first source data write (e.g., source data write 530a of FIG. 5) and a second source data write (e.g., source data write 530b of FIG. 5). The source writes may be direct writes to the source data store, duplicated writes from the target system, or combinations thereof. The target system receives a target data write (e.g., direct data write 538 of FIG. 5). The first source data write, second source data write, and the target data write may all be directed towards the same data (e.g., the same semantic objects) stored in the target system. In some examples, the first source data write or the second source data write may be a duplicated data write corresponding to the target data write. The first source data write and the second source data write may impact the same and/or different data stored in the source data system. For example, both data writes may update different data within the source system that map to the same semantic object within the target system.

At block 810, a semantic object version corresponding to each data write is generated with an associated watermark. One or more materializers (e.g., materializers 512a-b of FIG. 5) can generate semantic object versions (e.g., SO version 534a-b) corresponding to the first and second source data write after transactions related to the source data writes have been ingested via an ingestion flow. The materializers can determine watermarks (e.g., watermarks 536a-b of FIG. 5) corresponding to the semantic object versions based on a timestamp of one or more data reads (e.g., data reads 532a-b of FIG. 5) when retrieving relevant values associated with attributes of the semantic object. The target data write may be received as an SO version (e.g., SO version 534c of FIG. 5) and the target system can generate a direct watermark (e.g., placeholder watermark) by incrementing a current time by a time unit.

At block 815, the target system determines whether the watermark of the SO version is greater than the watermark of the SO stored in the target data store of the target system. The data writes can be executed in the order in which they finish processing and are provided for being written to the data store. For each SO version, the target system determines whether the watermark (e.g., the watermark determined by the materializer, the direct watermark determined for the target data write) is greater than the watermark of the stored SO.

At block 820, the SO version is written to the data store if the watermark is determined to be greater than the watermark of the stored SO. At block 825, the SO version is not written to the data store if the watermark is not determined to be greater than the watermark of the stored SO. The stored SO can be an SO version corresponding to a data write of the race condition that was successfully executed and written to the data store. For example, if the SO version correspond to the target data write is successfully written to the data store and the SO version corresponding the first source data write is subsequently attempted to be written, the target system may compare watermarks corresponding to the target data write and the first source data write. In some examples, if the data write is an insert and contains duplicated data, the semantic object version may not be written to the data store despite the watermark being greater than the watermark of the stored SO.

At block 830, the target system determines if there are additional unexecuted writes. If there are determined to be additional unexecuted writes, the flow 800 proceeds to 815 and a watermark comparison is performed. If there are no additional unexecuted writes, the flow 800 ends at block 835 until additional writes are received.

### Illustrative Methods

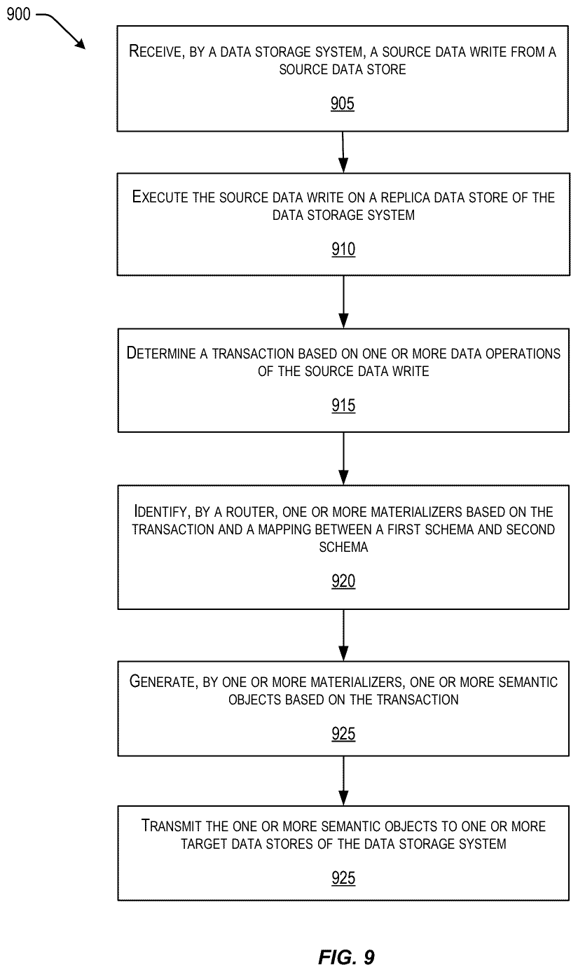

FIG. 9 is a flowchart of a process 900 for replicating a data transaction from a source data store to a target data store in accordance with various embodiments. The processing depicted in FIG. 9 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process presented in FIG. 9 and described below is intended to be illustrative and non-limiting. Although FIG. 9 illustrates the various processing steps occurring in a particular sequence or order, this is not intended to be limiting. In certain alternative embodiments, the steps may be performed in some different order or some steps may also be performed at least partially in parallel. In certain embodiments, the processing depicted in FIG. 9 may be performed by one or more of the components, computing devices, services, or the like, such as a data storage system, semantic index, etc., illustrated and described with respect to FIGS. 1-8.

At step 905, a data storage system (e.g., SI 102 of FIG. 1, SI 202 of FIG. 2) receives a source data write from a source data store (e.g., source data store 110 of FIG. 1, source database 204 of FIG. 2). The source data write may be a direct write to the source data store (e.g., source data write 530a of FIG. 5), a duplicated write from the data storage system (e.g., duplicated write 112 of FIG. 1), or a combination thereof. The source data store can be associated with a first schema and the data storage system can be associated with a second schema (e.g., a schema implementing a Semantic Object Model) that is different from the first schema.

In some examples, the data storage system may receive a second source data write (e.g., source data write 530b of FIG. 5) from the source data store. Additionally or alternatively, the data storage system can receive a target data write (e.g., direct data write 538 of FIG. 5). In some examples, the source data write may be generated based on the target data write as a duplicated data write. The duplicated data write may be transmitted to and executed on the source data store.

At step 910, the source data write is executed on a replica data store (e.g., replica database 208 of FIG. 2, replica database 508 of FIG. 5) of the data storage system. The replica data store may be associated the first schema. In some examples, executing the source data write on the replica data store can include identifying one or more data changes in the source data store by a CDC system and transmitting a replica transaction including the one or more data changes to the replica data store.

At step 915, a transaction (e.g., transaction 404 of FIG. 4) based on one or more data operations (e.g., data operations 406 of FIG. 4) of the source data write may be determined. In some examples, the transaction may be determined by a second CDC system that identifies and extracts data changes from a transaction log associated with the replica data store.

At step 920, a router (e.g., router(s) 210 of FIG. 2, router 402 of FIG. 4) can identify one or more materializers (e.g., materializer(s) 212 of FIG. 2, materializers 422a-422n of FIG. 4) based on the transaction and a mapping between the first schema and the second schema (e.g., as described with respect to data flow 300 of FIG. 3, router configuration 409 of FIG. 4). The router may identify, based on the transaction, one or more updated tables (e.g., tables 410 of FIG. 4) corresponding to the first schema. The router may identify, based on the mapping, one or more concepts associated with the one or more updated tables. The one or more concepts (e.g., SO clusters 308a-308n of FIG. 3) are defined by the second schema. In some examples, the one or more concepts may be defined by the first schema (e.g., table groups 306a-n of FIG. 3). The router may determine the one or more semantic objects (e.g., semantic objects 312a-312n of FIG. 3). For each semantic object of the one or more semantic objects, the router can identify a corresponding materializer of the one or more materializers. Generating the one or more semantic objects can include generating each semantic object of the one or more semantic objects using the corresponding materializer based on the transaction.

At step 925, the router may transmit the transaction to the one or more materializers. One or more data capture transactions (e.g., CDC payload chunk(s) 416 of FIG. 4) may be generated based on the transaction. Each of the one or more data capture transactions may include information (e.g., operation data) related to at least a subset of the one or more data operations. For each data capture transaction of the one or more data capture transactions, a dispatcher (e.g., dispatcher 418 of FIG. 4) may identify a semantic object queue (e.g., SO queues 420a-420n) corresponding to a relevant materializer of the one or more materializers and append the data capture transaction to the semantic object queue corresponding to the relevant materializer.

At step 930, the one or more materializers may generate one or more semantic objects (e.g., semantic objects 312a-n of FIG. 3) based on the transaction. Each materializer may identify a primary key associated with the transaction. The primary key may correspond to a semantic object. Based on the second schema, the materializer can determine one or more relevant values associated with the primary key. The materializer may retrieve the one or more relevant values from the replica data store (e.g., via data reads 532a-532b of FIG. 5). The materializer may determine a watermark (e.g., watermarks 536a-536b of FIG. 5) based on the retrieving. The watermark may include a timestamp. The semantic object may be generated based on the one or more relevant values and the watermark.

In some examples, a version of the one or more semantic objects may be generated based on the second source data write, and the version may be associated with a second watermark. In some examples, a placeholder watermark (e.g., a direct watermark) may be generated based on the target data write. The placeholder watermark may be generated based the direct data write and a current time value. For example, the placeholder watermark may be generated by incrementing a value of a time as determined based on a time determining mechanism (e.g., a clock) of the data storage system and/or component of the data storage system.

At step 935, the one or more semantic objects can be transmitted to one or more target data stores (e.g., target data stores 104a-n of FIG. 1) of the data storage system. The one or more target data stores may be associated with the second schema. The one or more target data stores can include a first target data store corresponding to a first data store type (e.g., relational database 220 of FIG. 2) and a second target data store corresponding to a second data store type (e.g., vector database 228 of FIG. 2).

In examples where the data storage system receives a first source data write and a second source data write, the process 900 can include determining whether the watermark associated with the first source data write is greater than the second watermark associated with the second source data write. In response to determining the watermark is greater than the second watermark, the one or more semantic objects corresponding to the first source data write can be written to the target data stores. In response to determining the watermark is not greater than the second watermark, the second source data write may be executed on the one or more target data stores by writing the one or more semantic object versions corresponding to the second source data write.

In examples where the data storage system receives a source data write and a direct data write, the process 900 can include determining whether the placeholder watermark corresponds to an expected value (e.g., whether the placeholder watermark is greater than a watermark of the written data). In response to determining the placeholder watermark corresponds to the expected value, the direct data write may be executed on the one or more target data stores by writing one or more semantic objects corresponding to the direct data write.

In examples where the data storage system receives a first source data write, a second source data write, and a direct data write (e.g., a target data write), the one or more semantic objects corresponding to one or more of the respective data writes may be written to the one or more target data stores based on the watermark associated with the first source data write, the second watermark associated with the second source data write, and the direct watermark associated with the direct data write. For example, each watermark may be compared to a watermark associated with one or more semantic objects stored in the one or more target data stores, and the target data write, source data write, second source data write, or a combination thereof may be executed based on the comparison(s).

In some examples, the process 900 may further include performing a first write operation comprising the one or more semantic objects on the first target data store (e.g., executing a SQL statement on the relational database 220 of FIG. 2). One or more converted semantic objects may be generated based on the first write operation by converting the one or more semantic objects to a format corresponding to the second data store type (e.g., by enricher 224 and vector indexer 226 of FIG. 2). A second write operation comprising the one or more converted semantic object can be performed on the second data store (e.g., storing a vector embedding in the vector database 228 of FIG. 2).

### Examples of Architectures for Implementing Cloud Infrastructures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 10 is a block diagram 1000 illustrating an example pattern of an IaaS architecture, according to at least one embodiment. Service operators 1002 can be communicatively coupled to a secure host tenancy 1004 that can include a virtual cloud network (VCN) 1006 and a secure host subnet 1008. In some examples, the service operators 1002 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1006 and/or the Internet.

The VCN 1006 can include a local peering gateway (LPG) 1010 that can be communicatively coupled to a secure shell (SSH) VCN 1012 via an LPG 1010 contained in the SSH VCN 1012. The SSH VCN 1012 can include an SSH subnet 1014, and the SSH VCN 1012 can be communicatively coupled to a control plane VCN 1016 via the LPG 1010 contained in the control plane VCN 1016. Also, the SSH VCN 1012 can be communicatively coupled to a data plane VCN 1018 via an LPG 1010. The control plane VCN 1016 and the data plane VCN 1018 can be contained in a service tenancy 1019 that can be owned and/or operated by the IaaS provider.

The control plane VCN 1016 can include a control plane demilitarized zone (DMZ) tier 1020 that acts as a perimeter network (e.g., portions of a corporate network between the corporate intranet and external networks). The DMZ-based servers may have restricted responsibilities and help keep breaches contained. Additionally, the DMZ tier 1020 can include one or more load balancer (LB) subnet(s) 1022, a control plane app tier 1024 that can include app subnet(s) 1026, a control plane data tier 1028 that can include database (DB) subnet(s) 1030 (e.g., frontend DB subnet(s) and/or backend DB subnet(s)). The LB subnet(s) 1022 contained in the control plane DMZ tier 1020 can be communicatively coupled to the app subnet(s) 1026 contained in the control plane app tier 1024 and an Internet gateway 1034 that can be contained in the control plane VCN 1016, and the app subnet(s) 1026 can be communicatively coupled to the DB subnet(s) 1030 contained in the control plane data tier 1028 and a service gateway 1036 and a network address translation (NAT) gateway 1038. The control plane VCN 1016 can include the service gateway 1036 and the NAT gateway 1038.

The control plane VCN 1016 can include a data plane mirror app tier 1040 that can include app subnet(s) 1026. The app subnet(s) 1026 contained in the data plane mirror app tier 1040 can include a virtual network interface controller (VNIC) 1042 that can execute a compute instance 1044. The compute instance 1044 can communicatively couple the app subnet(s) 1026 of the data plane mirror app tier 1040 to app subnet(s) 1026 that can be contained in a data plane app tier 1046.

The data plane VCN 1018 can include the data plane app tier 1046, a data plane DMZ tier 1048, and a data plane data tier 1050. The data plane DMZ tier 1048 can include LB subnet(s) 1022 that can be communicatively coupled to the app subnet(s) 1026 of the data plane app tier 1046 and the Internet gateway 1034 of the data plane VCN 1018. The app subnet(s) 1026 can be communicatively coupled to the service gateway 1036 of the data plane VCN 1018 and the NAT gateway 1038 of the data plane VCN 1018. The data plane data tier 1050 can also include the DB subnet(s) 1030 that can be communicatively coupled to the app subnet(s) 1026 of the data plane app tier 1046.

The Internet gateway 1034 of the control plane VCN 1016 and of the data plane VCN 1018 can be communicatively coupled to a metadata management service 1052 that can be communicatively coupled to public Internet 1054. Public Internet 1054 can be communicatively coupled to the NAT gateway 1038 of the control plane VCN 1016 and of the data plane VCN 1018. The service gateway 1036 of the control plane VCN 1016 and of the data plane VCN 1018 can be communicatively coupled to cloud services 1056.

In some examples, the service gateway 1036 of the control plane VCN 1016 or of the data plane VCN 1018 can make application programming interface (API) calls to cloud services 1056 without going through public Internet 1054. The API calls to cloud services 1056 from the service gateway 1036 can be one-way: the service gateway 1036 can make API calls to cloud services 1056, and cloud services 1056 can send requested data to the service gateway 1036. But, cloud services 1056 may not initiate API calls to the service gateway 1036.

In some examples, the secure host tenancy 1004 can be directly connected to the service tenancy 1019, which may be otherwise isolated. The secure host subnet 1008 can communicate with the SSH subnet 1014 through an LPG 1010 that may enable two-way communication over an otherwise isolated system. Connecting the secure host subnet 1008 to the SSH subnet 1014 may give the secure host subnet 1008 access to other entities within the service tenancy 1019.

The control plane VCN 1016 may allow users of the service tenancy 1019 to set up or otherwise provision desired resources. Desired resources provisioned in the control plane VCN 1016 may be deployed or otherwise used in the data plane VCN 1018. In some examples, the control plane VCN 1016 can be isolated from the data plane VCN 1018, and the data plane mirror app tier 1040 of the control plane VCN 1016 can communicate with the data plane app tier 1046 of the data plane VCN 1018 via VNICs 1042 that can be contained in the data plane mirror app tier 1040 and the data plane app tier 1046.

In some examples, users of the system, or customers, can make requests, for example create, read, update, or delete (CRUD) operations, through public Internet 1054 that can communicate the requests to the metadata management service 1052. The metadata management service 1052 can communicate the request to the control plane VCN 1016 through the Internet gateway 1034. The request can be received by the LB subnet(s) 1022 contained in the control plane DMZ tier 1020. The LB subnet(s) 1022 may determine that the request is valid, and in response to this determination, the LB subnet(s) 1022 can transmit the request to app subnet(s) 1026 contained in the control plane app tier 1024. If the request is validated and requires a call to public Internet 1054, the call to public Internet 1054 may be transmitted to the NAT gateway 1038 that can make the call to public Internet 1054. Metadata that may be desired to be stored by the request can be stored in the DB subnet(s) 1030.

In some examples, the data plane mirror app tier 1040 can facilitate direct communication between the control plane VCN 1016 and the data plane VCN 1018. For example, changes, updates, or other suitable modifications to configuration may be desired to be applied to the resources contained in the data plane VCN 1018. Via a VNIC 1042, the control plane VCN 1016 can directly communicate with, and can thereby execute the changes, updates, or other suitable modifications to configuration to, resources contained in the data plane VCN 1018.

In some embodiments, the control plane VCN 1016 and the data plane VCN 1018 can be contained in the service tenancy 1019. In this case, the user, or the customer, of the system may not own or operate either the control plane VCN 1016 or the data plane VCN 1018. Instead, the IaaS provider may own or operate the control plane VCN 1016 and the data plane VCN 1018, both of which may be contained in the service tenancy 1019. This embodiment can enable isolation of networks that may prevent users or customers from interacting with other users', or other customers', resources. Also, this embodiment may allow users or customers of the system to store databases privately without needing to rely on public Internet 1054, which may not have a desired level of threat prevention, for storage.

In other embodiments, the LB subnet(s) 1022 contained in the control plane VCN 1016 can be configured to receive a signal from the service gateway 1036. In this embodiment, the control plane VCN 1016 and the data plane VCN 1018 may be configured to be called by a customer of the IaaS provider without calling public Internet 1054. Customers of the IaaS provider may desire this embodiment since database(s) that the customers use may be controlled by the IaaS provider and may be stored on the service tenancy 1019, which may be isolated from public Internet 1054.

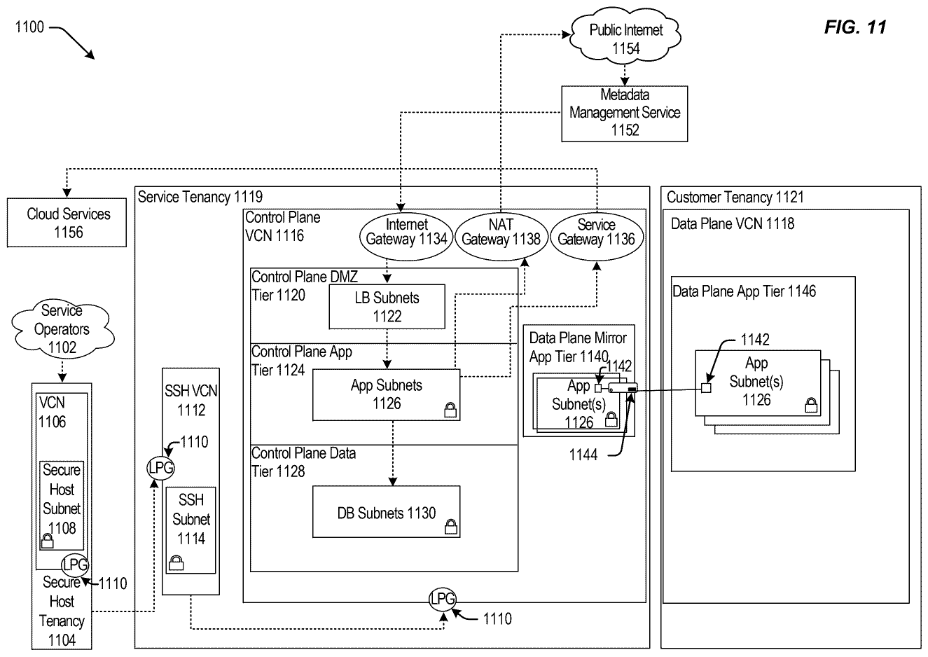

FIG. 11 is a block diagram 1100 illustrating another example pattern of an IaaS architecture, according to at least one embodiment. Service operators 1102 (e.g., service operators 1002 of FIG. 10) can be communicatively coupled to a secure host tenancy 1104 (e.g., the secure host tenancy 1004 of FIG. 10) that can include a virtual cloud network (VCN) 1106 (e.g., the VCN 1006 of FIG. 10) and a secure host subnet 1108 (e.g., the secure host subnet 1008 of FIG. 10). The VCN 1106 can include a local peering gateway (LPG) 1110 (e.g., the LPG 1010 of FIG. 10) that can be communicatively coupled to a secure shell (SSH) VCN 1112 (e.g., the SSH VCN 1012 of FIG. 10) via an LPG 1010 contained in the SSH VCN 1112. The SSH VCN 1112 can include an SSH subnet 1114 (e.g., the SSH subnet 1014 of FIG. 10), and the SSH VCN 1112 can be communicatively coupled to a control plane VCN 1116 (e.g., the control plane VCN 1016 of FIG. 10) via an LPG 1110 contained in the control plane VCN 1116. The control plane VCN 1116 can be contained in a service tenancy 1119 (e.g., the service tenancy 1019 of FIG. 10), and the data plane VCN 1118 (e.g., the data plane VCN 1018 of FIG. 10) can be contained in a customer tenancy 1121 that may be owned or operated by users, or customers, of the system.

The control plane VCN 1116 can include a control plane DMZ tier 1120 (e.g., the control plane DMZ tier 1020 of FIG. 10) that can include LB subnet(s) 1122 (e.g., LB subnet(s) 1022 of FIG. 10), a control plane app tier 1124 (e.g., the control plane app tier 1024 of FIG. 10) that can include app subnet(s) 1126 (e.g., app subnet(s) 1026 of FIG. 10), a control plane data tier 1128 (e.g., the control plane data tier 1028 of FIG. 10) that can include database (DB) subnet(s) 1130 (e.g., similar to DB subnet(s) 1030 of FIG. 10). The LB subnet(s) 1122 contained in the control plane DMZ tier 1120 can be communicatively coupled to the app subnet(s) 1126 contained in the control plane app tier 1124 and an Internet gateway 1134 (e.g., the Internet gateway 1034 of FIG. 10) that can be contained in the control plane VCN 1116, and the app subnet(s) 1126 can be communicatively coupled to the DB subnet(s) 1130 contained in the control plane data tier 1128 and a service gateway 1136 (e.g., the service gateway 1036 of FIG. 10) and a network address translation (NAT) gateway 1138 (e.g., the NAT gateway 1038 of FIG. 10). The control plane VCN 1116 can include the service gateway 1136 and the NAT gateway 1138.

The control plane VCN 1116 can include a data plane mirror app tier 1140 (e.g., the data plane mirror app tier 1040 of FIG. 10) that can include app subnet(s) 1126. The app subnet(s) 1126 contained in the data plane mirror app tier 1140 can include a virtual network interface controller (VNIC) 1142 (e.g., the VNIC of 1042) that can execute a compute instance 1144 (e.g., similar to the compute instance 1044 of FIG. 10). The compute instance 1144 can facilitate communication between the app subnet(s) 1126 of the data plane mirror app tier 1140 and the app subnet(s) 1126 that can be contained in a data plane app tier 1146 (e.g., the data plane app tier 1046 of FIG. 10) via the VNIC 1142 contained in the data plane mirror app tier 1140 and the VNIC 1142 contained in the data plane app tier 1146.

The Internet gateway 1134 contained in the control plane VCN 1116 can be communicatively coupled to a metadata management service 1152 (e.g., the metadata management service 1052 of FIG. 10) that can be communicatively coupled to public Internet 1154 (e.g., public Internet 1054 of FIG. 10). Public Internet 1154 can be communicatively coupled to the NAT gateway 1138 contained in the control plane VCN 1116. The service gateway 1136 contained in the control plane VCN 1116 can be communicatively coupled to cloud services 1156 (e.g., cloud services 1056 of FIG. 10).

In some examples, the data plane VCN 1118 can be contained in the customer tenancy 1121. In this case, the IaaS provider may provide the control plane VCN 1116 for each customer, and the IaaS provider may, for each customer, set up a unique compute instance 1144 that is contained in the service tenancy 1119. Each compute instance 1144 may allow communication between the control plane VCN 1116, contained in the service tenancy 1119, and the data plane VCN 1118 that is contained in the customer tenancy 1121. The compute instance 1144 may allow resources, that are provisioned in the control plane VCN 1116 that is contained in the service tenancy 1119, to be deployed or otherwise used in the data plane VCN 1118 that is contained in the customer tenancy 1121.

In other examples, the customer of the IaaS provider may have databases that live in the customer tenancy 1121. In this example, the control plane VCN 1116 can include the data plane mirror app tier 1140 that can include app subnet(s) 1126. The data plane mirror app tier 1140 can reside in the data plane VCN 1118, but the data plane mirror app tier 1140 may not live in the data plane VCN 1118. That is, the data plane mirror app tier 1140 may have access to the customer tenancy 1121, but the data plane mirror app tier 1140 may not exist in the data plane VCN 1118 or be owned or operated by the customer of the IaaS provider. The data plane mirror app tier 1140 may be configured to make calls to the data plane VCN 1118 but may not be configured to make calls to any entity contained in the control plane VCN 1116. The customer may desire to deploy or otherwise use resources in the data plane VCN 1118 that are provisioned in the control plane VCN 1116, and the data plane mirror app tier 1140 can facilitate the desired deployment, or other usage of resources, of the customer.

In some embodiments, the customer of the IaaS provider can apply filters to the data plane VCN 1118. In this embodiment, the customer can determine what the data plane VCN 1118 can access, and the customer may restrict access to public Internet 1154 from the data plane VCN 1118. The IaaS provider may not be able to apply filters or otherwise control access of the data plane VCN 1118 to any outside networks or databases. Applying filters and controls by the customer onto the data plane VCN 1118, contained in the customer tenancy 1121, can help isolate the data plane VCN 1118 from other customers and from public Internet 1154.

In some embodiments, cloud services 1156 can be called by the service gateway 1136 to access services that may not exist on public Internet 1154, on the control plane VCN 1116, or on the data plane VCN 1118. The connection between cloud services 1156 and the control plane VCN 1116 or the data plane VCN 1118 may not be live or continuous. Cloud services 1156 may exist on a different network owned or operated by the IaaS provider. Cloud services 1156 may be configured to receive calls from the service gateway 1136 and may be configured to not receive calls from public Internet 1154. Some cloud services 1156 may be isolated from other cloud services 1156, and the control plane VCN 1116 may be isolated from cloud services 1156 that may not be in the same region as the control plane VCN 1116. For example, the control plane VCN 1116 may be located in “Region 1,” and cloud service “Deployment 10,” may be located in Region 1 and in “Region 2.” If a call to Deployment 10 is made by the service gateway 1136 contained in the control plane VCN 1116 located in Region 1, the call may be transmitted to Deployment 10 in Region 1. In this example, the control plane VCN 1116, or Deployment 10 in Region 1, may not be communicatively coupled to, or otherwise in communication with, Deployment 10 in Region 2.

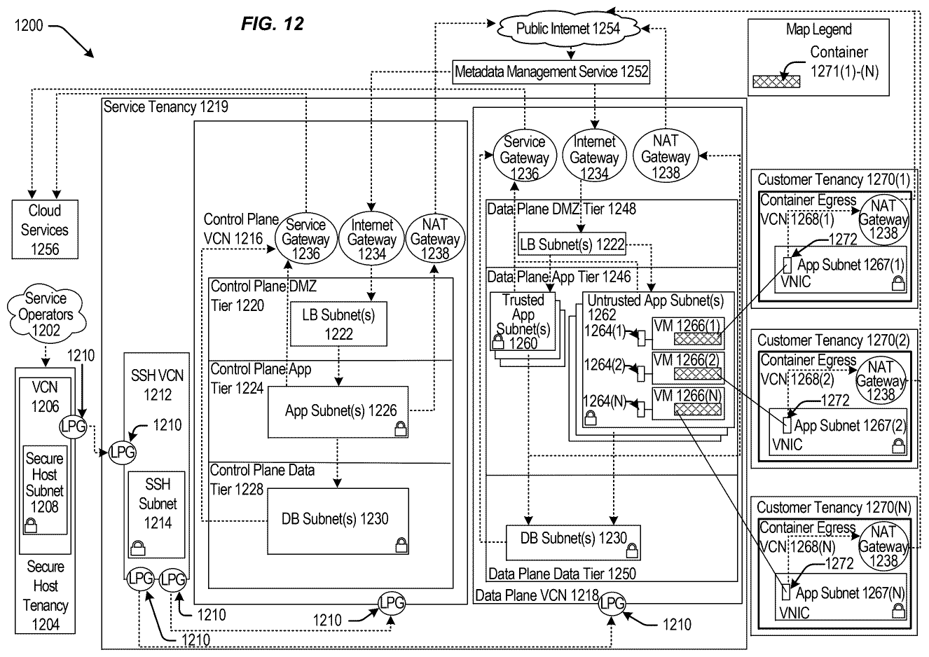

FIG. 12 is a block diagram 1200 illustrating another example pattern of an IaaS architecture, according to at least one embodiment. Service operators 1202 (e.g., service operators 1002 of FIG. 10) can be communicatively coupled to a secure host tenancy 1204 (e.g., the secure host tenancy 1004 of FIG. 10) that can include a virtual cloud network (VCN) 1206 (e.g., the VCN 1006 of FIG. 10) and a secure host subnet 1208 (e.g., the secure host subnet 1008 of FIG. 10). The VCN 1206 can include an LPG 1210 (e.g., the LPG 1010 of FIG. 10) that can be communicatively coupled to an SSH VCN 1212 (e.g., the SSH VCN 1012 of FIG. 10) via an LPG 1210 contained in the SSH VCN 1212. The SSH VCN 1212 can include an SSH subnet 1214 (e.g., the SSH subnet 1014 of FIG. 10), and the SSH VCN 1212 can be communicatively coupled to a control plane VCN 1216 (e.g., the control plane VCN 1016 of FIG. 10) via an LPG 1210 contained in the control plane VCN 1216 and to a data plane VCN 1218 (e.g., the data plane 1018 of FIG. 10) via an LPG 1210 contained in the data plane VCN 1218. The control plane VCN 1216 and the data plane VCN 1218 can be contained in a service tenancy 1219 (e.g., the service tenancy 1019 of FIG. 10).

The control plane VCN 1216 can include a control plane DMZ tier 1220 (e.g., the control plane DMZ tier 1020 of FIG. 10) that can include load balancer (LB) subnet(s) 1222 (e.g., LB subnet(s) 1022 of FIG. 10), a control plane app tier 1224 (e.g., the control plane app tier 1024 of FIG. 10) that can include app subnet(s) 1226 (e.g., similar to app subnet(s) 1026 of FIG. 10), a control plane data tier 1228 (e.g., the control plane data tier 1028 of FIG. 10) that can include DB subnet(s) 1230. The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 1034 of FIG. 10) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 10) and a network address translation (NAT) gateway 1238 (e.g., the NAT gateway 1038 of FIG. 10). The control plane VCN 1216 can include the service gateway 1236 and the NAT gateway 1238.

The data plane VCN 1218 can include a data plane app tier 1246 (e.g., the data plane app tier 1046 of FIG. 10), a data plane DMZ tier 1248 (e.g., the data plane DMZ tier 1048 of FIG. 10), and a data plane data tier 1250 (e.g., the data plane data tier 1050 of FIG. 10). The data plane DMZ tier 1248 can include LB subnet(s) 1222 that can be communicatively coupled to trusted app subnet(s) 1260 and untrusted app subnet(s) 1262 of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include one or more primary VNICs 1264(1)-(N) that can be communicatively coupled to tenant virtual machines (VMs) 1266(1)-(N). Each tenant VM 1266(1)-(N) can be communicatively coupled to a respective app subnet 1267(1)-(N) that can be contained in respective container egress VCNs 1268(1)-(N) that can be contained in respective customer tenancies 1270(1)-(N). Respective secondary VNICs 1272(1)-(N) can facilitate communication between the untrusted app subnet(s) 1262 contained in the data plane VCN 1218 and the app subnet contained in the container egress VCNs 1268(1)-(N). Each container egress VCNs 1268(1)-(N) can include a NAT gateway 1238 that can be communicatively coupled to public Internet 1254 (e.g., public Internet 1054 of FIG. 10).

The Internet gateway 1234 contained in the control plane VCN 1216 and contained in the data plane VCN 1218 can be communicatively coupled to a metadata management service 1252 (e.g., the metadata management system 1052 of FIG. 10) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively coupled to cloud services 1256.

In some embodiments, the data plane VCN 1218 can be integrated with customer tenancies 1270. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1246. Code to run the function may be executed in the VMs 1266(1)-(N), and the code may not be configured to run anywhere else on the data plane VCN 1218. Each VM 1266(1)-(N) may be connected to one customer tenancy 1270. Respective containers 1271(1)-(N) contained in the VMs 1266(1)-(N) may be configured to run the code. In this case, there can be a dual isolation (e.g., the containers 1271(1)-(N) running code, where the containers 1271(1)-(N) may be contained in at least the VM 1266(1)-(N) that are contained in the untrusted app subnet(s) 1262), which may help prevent incorrect or otherwise undesirable code from damaging the network of the IaaS provider or from damaging a network of a different customer. The containers 1271(1)-(N) may be communicatively coupled to the customer tenancy 1270 and may be configured to transmit or receive data from the customer tenancy 1270. The containers 1271(1)-(N) may not be configured to transmit or receive data from any other entity in the data plane VCN 1218. Upon completion of running the code, the IaaS provider may kill or otherwise dispose of the containers 1271(1)-(N).

In some embodiments, the trusted app subnet(s) 1260 may run code that may be owned or operated by the IaaS provider. In this embodiment, the trusted app subnet(s) 1260 may be communicatively coupled to the DB subnet(s) 1230 and be configured to execute CRUD operations in the DB subnet(s) 1230. The untrusted app subnet(s) 1262 may be communicatively coupled to the DB subnet(s) 1230, but in this embodiment, the untrusted app subnet(s) may be configured to execute read operations in the DB subnet(s) 1230. The containers 1271(1)-(N) that can be contained in the VM 1266(1)-(N) of each customer and that may run code from the customer may not be communicatively coupled with the DB subnet(s) 1230.

In other embodiments, the control plane VCN 1216 and the data plane VCN 1218 may not be directly communicatively coupled. In this embodiment, there may be no direct communication between the control plane VCN 1216 and the data plane VCN 1218. However, communication can occur indirectly through at least one method. An LPG 1210 may be established by the IaaS provider that can facilitate communication between the control plane VCN 1216 and the data plane VCN 1218. In another example, the control plane VCN 1216 or the data plane VCN 1218 can make a call to cloud services 1256 via the service gateway 1236. For example, a call to cloud services 1256 from the control plane VCN 1216 can include a request for a service that can communicate with the data plane VCN 1218.

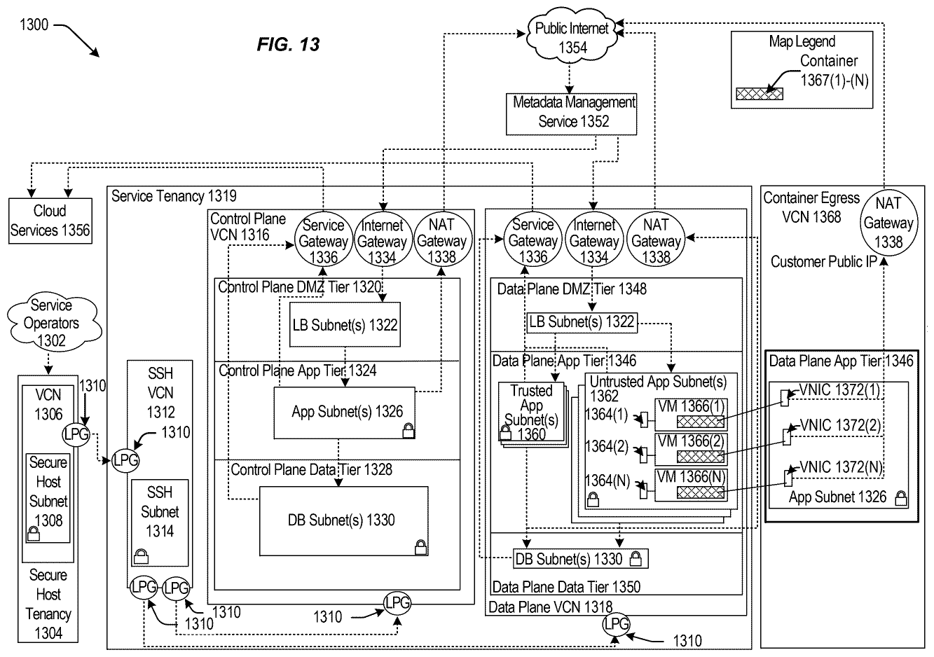

FIG. 13 is a block diagram 1300 illustrating another example pattern of an IaaS architecture, according to at least one embodiment. Service operators 1302 (e.g., service operators 1002 of FIG. 10) can be communicatively coupled to a secure host tenancy 1304 (e.g., the secure host tenancy 1004 of FIG. 10) that can include a virtual cloud network (VCN) 1306 (e.g., the VCN 1006 of FIG. 10) and a secure host subnet 1308 (e.g., the secure host subnet 1008 of FIG. 10). The VCN 1306 can include an LPG 1310 (e.g., the LPG 1010 of FIG. 10) that can be communicatively coupled to an SSH VCN 1312 (e.g., the SSH VCN 1012 of FIG. 10) via an LPG 1310 contained in the SSH VCN 1312. The SSH VCN 1312 can include an SSH subnet 1314 (e.g., the SSH subnet 1014 of FIG. 10), and the SSH VCN 1312 can be communicatively coupled to a control plane VCN 1316 (e.g., the control plane VCN 1016 of FIG. 10) via an LPG 1310 contained in the control plane VCN 1316 and to a data plane VCN 1318 (e.g., the data plane 1018 of FIG. 10) via an LPG 1310 contained in the data plane VCN 1318. The control plane VCN 1316 and the data plane VCN 1318 can be contained in a service tenancy 1319 (e.g., the service tenancy 1019 of FIG. 10).

The control plane VCN 1316 can include a control plane DMZ tier 1320 (e.g., the control plane DMZ tier 1020 of FIG. 10) that can include LB subnet(s) 1322 (e.g., LB subnet(s) 1022 of FIG. 10), a control plane app tier 1324 (e.g., the control plane app tier 1024 of FIG. 10) that can include app subnet(s) 1326 (e.g., app subnet(s) 1026 of FIG. 10), a control plane data tier 1328 (e.g., the control plane data tier 1028 of FIG. 10) that can include DB subnet(s) 1330 (e.g., DB subnet(s) 1230 of FIG. 12). The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1034 of FIG. 10) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 10) and a network address translation (NAT) gateway 1338 (e.g., the NAT gateway 1038 of FIG. 10). The control plane VCN 1316 can include the service gateway 1336 and the NAT gateway 1338.

The data plane VCN 1318 can include a data plane app tier 1346 (e.g., the data plane app tier 1046 of FIG. 10), a data plane DMZ tier 1348 (e.g., the data plane DMZ tier 1048 of FIG. 10), and a data plane data tier 1350 (e.g., the data plane data tier 1050 of FIG. 10). The data plane DMZ tier 1348 can include LB subnet(s) 1322 that can be communicatively coupled to trusted app subnet(s) 1360 (e.g., trusted app subnet(s) 1260 of FIG. 12) and untrusted app subnet(s) 1362 (e.g., untrusted app subnet(s) 1262 of FIG. 12) of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include primary VNICs 1364(1)-(N) that can be communicatively coupled to tenant virtual machines (VMs) 1366(1)-(N) residing within the untrusted app subnet(s) 1362. Each tenant VM 1366(1)-(N) can run code in a respective container 1367(1)-(N), and be communicatively coupled to an app subnet 1326 that can be contained in a data plane app tier 1346 that can be contained in a container egress VCN 1368.

Respective secondary VNICs 1372(1)-(N) can facilitate communication between the untrusted app subnet(s) 1362 contained in the data plane VCN 1318 and the app subnet contained in the container egress VCN 1368. The container egress VCN can include a NAT gateway 1338 that can be communicatively coupled to public Internet 1354 (e.g., public Internet 1054 of FIG. 10).

The Internet gateway 1334 contained in the control plane VCN 1316 and contained in the data plane VCN 1318 can be communicatively coupled to a metadata management service 1352 (e.g., the metadata management system 1052 of FIG. 10) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively coupled to cloud services 1356.

In some examples, the pattern illustrated by the architecture of block diagram 1300 of FIG. 13 may be considered an exception to the pattern illustrated by the architecture of block diagram 1200 of FIG. 12 and may be desirable for a customer of the IaaS provider if the IaaS provider cannot directly communicate with the customer (e.g., a disconnected region). The respective containers 1367(1)-(N) that are contained in the VMs 1366(1)-(N) for each customer can be accessed in real-time by the customer. The containers 1367(1)-(N) may be configured to make calls to respective secondary VNICs 1372(1)-(N) contained in app subnet(s) 1326 of the data plane app tier 1346 that can be contained in the container egress VCN 1368. The secondary VNICs 1372(1)-(N) can transmit the calls to the NAT gateway 1338 that may transmit the calls to public Internet 1354. In this example, the containers 1367(1)-(N) that can be accessed in real-time by the customer can be isolated from the control plane VCN 1316 and can be isolated from other entities contained in the data plane VCN 1318. The containers 1367(1)-(N) may also be isolated from resources from other customers.

In other examples, the customer can use the containers 1367(1)-(N) to call cloud services 1356. In this example, the customer may run code in the containers 1367(1)-(N) that requests a service from cloud services 1356. The containers 1367(1)-(N) can transmit this request to the secondary VNICs 1372(1)-(N) that can transmit the request to the NAT gateway that can transmit the request to public Internet 1354. Public Internet 1354 can transmit the request to LB subnet(s) 1322 contained in the control plane VCN 1316 via the Internet gateway 1334. In response to determining the request is valid, the LB subnet(s) can transmit the request to app subnet(s) 1326 that can transmit the request to cloud services 1356 via the service gateway 1336.

It should be appreciated that IaaS architectures 1000, 1100, 1200, 1300 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

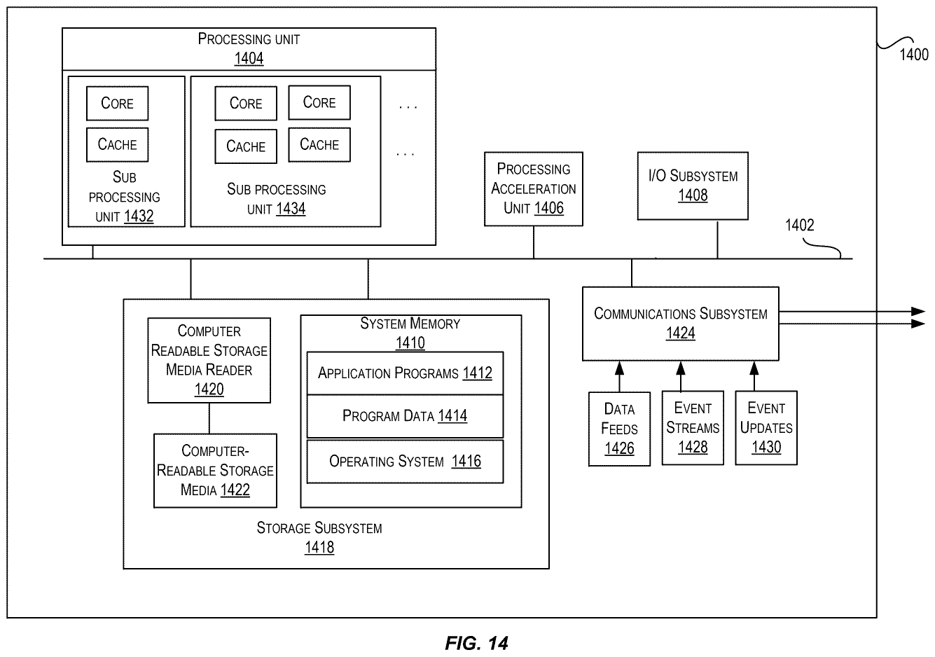

FIG. 14 illustrates an example computer system 1400, in which various embodiments may be implemented. The system 1400 may be used to implement any of the computer systems described above. As shown in the figure, computer system 1400 includes a processing unit 1404 that communicates with a number of peripheral subsystems via a bus subsystem 1402. These peripheral subsystems may include a processing acceleration unit 1406, an I/O subsystem 1408, a storage subsystem 1418 and a communications subsystem 1424. Storage subsystem 1418 includes tangible computer-readable storage media 1422 and a system memory 1410.

Bus subsystem 1402 provides a mechanism for letting the various components and subsystems of computer system 1400 communicate with each other as intended. Although bus subsystem 1402 is shown schematically as a single bus, alternative embodiments of the bus subsystem may utilize multiple buses. Bus subsystem 1402 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1404, which can be implemented as one or more integrated circuits (e.g., a conventional microprocessor or microcontroller), controls the operation of computer system 1400. One or more processors may be included in processing unit 1404. These processors may include single core or multicore processors. In certain embodiments, processing unit 1404 may be implemented as one or more independent processing units 1432 and/or 1434 with single or multicore processors included in each processing unit. In other embodiments, processing unit 1404 may also be implemented as a quad-core processing unit formed by integrating two dual-core processors into a single chip.

In various embodiments, processing unit 1404 can execute a variety of programs in response to program code and can maintain multiple concurrently executing programs or processes. At any given time, some or all of the program code to be executed can be resident in processor(s) 1404 and/or in storage subsystem 1418. Through suitable programming, processor(s) 1404 can provide various functionalities described above. Computer system 1400 may additionally include a processing acceleration unit 1406, which can include a digital signal processor (DSP), a special-purpose processor, and/or the like.

I/O subsystem 1408 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1400 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1400 may comprise a storage subsystem 1418 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1404 provide the functionality described above. Storage subsystem 1418 may also provide a repository for storing data used in accordance with the present disclosure.

As depicted in the example in FIG. 14, storage subsystem 1418 can include various components including a system memory 1410, computer-readable storage media 1422, and a computer readable storage media reader 1420. System memory 1410 may store program instructions that are loadable and executable by processing unit 1404. System memory 1410 may also store data that is used during the execution of the instructions and/or data that is generated during the execution of the program instructions. Various different kinds of programs may be loaded into system memory 1410 including but not limited to client applications, Web browsers, mid-tier applications, relational database management systems (RDBMS), virtual machines, containers, etc.

System memory 1410 may also store an operating system 1416. Examples of operating system 1416 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1400 executes one or more virtual machines, the virtual machines along with their guest operating systems (GOSs) may be loaded into system memory 1410 and executed by one or more processors or cores of processing unit 1404.

System memory 1410 can come in different configurations depending upon the type of computer system 1400. For example, system memory 1410 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1410 may include a basic input/output system (BIOS) containing basic routines that help to transfer information between elements within computer system 1400, such as during start-up.

Computer-readable storage media 1422 may represent remote, local, fixed, and/or removable storage devices plus storage media for temporarily and/or more permanently containing, storing, computer-readable information for use by computer system 1400 including instructions executable by processing unit 1404 of computer system 1400.

Computer-readable storage media 1422 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1422 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1422 may include, but is not limited to, Zip® drives, flash memory cards, universal serial bus (USB) flash drives, secure digital (SD) cards, DVD disks, digital video tape, and the like. Computer-readable storage media 1422 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1400.

Machine-readable instructions executable by one or more processors or cores of processing unit 1404 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1424 provides an interface to other computer systems and networks. Communications subsystem 1424 serves as an interface for receiving data from and transmitting data to other systems from computer system 1400. For example, communications subsystem 1424 may enable computer system 1400 to connect to one or more devices via the Internet. In some embodiments communications subsystem 1424 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1424 can provide wired network connectivity (e.g., Ethernet) in addition to or instead of a wireless interface.

In some embodiments, communications subsystem 1424 may also receive input communication in the form of structured and/or unstructured data feeds 1426, event streams 1428, event updates 1430, and the like on behalf of one or more users who may use computer system 1400.

By way of example, communications subsystem 1424 may be configured to receive data feeds 1426 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1424 may also be configured to receive data in the form of continuous data streams, which may include event streams 1428 of real-time events and/or event updates 1430, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1424 may also be configured to output the structured and/or unstructured data feeds 1426, event streams 1428, event updates 1430, and the like to one or more databases that may be in communication with one or more streaming data source computers coupled to computer system 1400.

Computer system 1400 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1400 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
receiving, by a data storage system, a source data write from a source data store, wherein:
the source data write is (i) a direct write to the source data store, (ii) a duplicated write from the data storage system, or (iii) a combination thereof,
the source data store is associated with a first schema, and
the data storage system is associated with a second schema that is different from the first schema;
executing the source data write on a replica data store of the data storage system, wherein the replica data store is associated with the first schema;
determining a transaction based on one or more data operations of the source data write;
identifying, by a router, one or more materializers based on the transaction and a mapping between the first schema and the second schema;
transmitting, by the router, the transaction to the one or more materializers;
generating, by the one or more materializers, one or more semantic objects based on the transaction; and
transmitting the one or more semantic objects to one or more target data stores of the data storage system, wherein the one or more target data stores are associated with the second schema.

2. The computer-implemented method of claim 1, wherein:
the one or more target data stores comprise a first target data store corresponding to a first data store type and a second target data store corresponding to a second data store type; and
the computer-implemented method further comprises:
performing, on the first target data store, a first write operation comprising the one or more semantic objects;
generating, based on the first write operation, one or more converted semantic objects by converting the one or more semantic objects to a format corresponding to the second data store type; and
performing, on the second target data store, a second write operation comprising the one or more converted semantic objects.

3. The computer-implemented method of claim 1, wherein identifying the one or more materializers comprises:
identifying, based on the transaction, one or more updated tables corresponding to the first schema;
identifying, based on the mapping, one or more concepts associated with the one or more updated tables, wherein the one or more concepts are defined by the second schema;
determining, based on the one or more concepts, the one or more semantic objects; and
identifying, for each semantic object of the one or more semantic objects, a corresponding materializer of the one or more materializers, wherein generating the one or more semantic objects comprises generating each semantic object of the one or more semantic objects using the corresponding materializer based on the transaction.

4. The computer-implemented method of claim 1, wherein transmitting the transaction comprises:
generating, based on the transaction, one or more data capture transactions, wherein each of the one or more data capture transactions comprise at least a subset of the one or more data operations; and
for each data capture transaction of the one or more data capture transactions:
identifying, by a dispatcher, a semantic object queue corresponding to a relevant materializer of the one or more materializers, and
appending the data capture transaction to the semantic object queue corresponding to the relevant materializer.

5. The computer-implemented method of claim 1, wherein generating the one or more semantic objects comprises, for each materializer of the one or more materializers:
identifying a primary key associated with the transaction, wherein the primary key corresponds to a semantic object;
determining, based on the second schema, one or more relevant values associated with the primary key;
retrieving the one or more relevant values from the replica data store;
determining a watermark based on the retrieving, wherein the watermark comprises a timestamp; and
generating the semantic object based on the one or more relevant values and the watermark.

6. The computer-implemented method of claim 5, further comprising:
receiving, at the data storage system, a second source data write from the source data store, wherein the second source data write corresponds to the one or more semantic objects;
generating a version of the one or more semantic objects based on the second source data write, wherein the version is associated with a second watermark;
determining whether the watermark is greater than the second watermark;
responsive to determining the watermark is greater than the second watermark, writing the one or more semantic objects to the one or more target data stores; and
responsive to determining the watermark is not greater than the second watermark, executing the second source data write on the one or more target data stores.

7. The computer-implemented method of claim 6, wherein the source data write is a duplicated write from the data storage system, and wherein the computer-implemented method further comprises:
receiving, at the data storage system, a target data write;
generating the source data write based on the target data write;
generating a direct watermark based on the target data write; and
writing, at the one or more target data stores, the one or more semantic objects corresponding to (i) the target data write, (ii) the source data write, (iii) the second source data write, or (iv) a combination thereof, based on the watermark, the second watermark, and the direct watermark.

8. The computer-implemented method of claim 5, wherein the source data write is a duplicated write from the data storage system, and wherein the computer-implemented method further comprises:
receiving, at the data storage system, a direct data write;
generating the source data write based on the direct data write;
transmitting the duplicated write to the source data store;
generating a placeholder watermark based on the direct data write and a current time value;
determining whether the placeholder watermark corresponds to an expected watermark value; and
responsive to determining the placeholder watermark corresponds to the expected watermark value, executing the direct data write on the one or more target data stores.

9. The computer-implemented method of claim 1, further comprising:
receiving, by the data storage system, a query for a semantic object from a user;
retrieving the semantic object from a target data store of the one or more target data stores; and
providing the semantic object to the user.

10. A system comprising:
a source data store associated with a first schema;
a data storage system associated with a second schema that is different from the first schema;
one or more processors; and
one or more computer-readable media storing instructions which, when executed by the one or more processors, cause the system to perform operations comprising:
receiving, at the source data store, a source data write comprising one or more data operations, wherein the source data write is (i) a direct write, (ii) a duplicated write from a data storage system, or (iii) combinations thereof;
transmitting, from the source data store, the source data write to the data storage system; and
performing, by the data storage system, an ingestion process on the source data write, wherein the ingestion process comprises:
executing the source data write on a replica data store of the data storage system, wherein the replica data store is associated with the first schema,
determining a transaction based on one or more data operations of the source data write;
identifying, by a router, one or more materializers based on the transaction and a mapping between the first schema and the second schema;
transmitting, by the router, the transaction to the one or more materializers;
generating, by the one or more materializers, one or more semantic objects based on the transaction; and
transmitting the one or more semantic objects to one or more target data stores of the data storage system, wherein the one or more target data stores are associated with the second schema.

11. The system of claim 10, wherein identifying the one or more materializers comprises:
identifying, based on the transaction, one or more updated tables corresponding to the first schema;
identifying, based on the mapping, one or more concepts associated with the one or more updated tables, wherein the one or more concepts are defined by the second schema;
determining, based on the one or more concepts, the one or more semantic objects; and
identifying, for each semantic object of the one or more semantic objects, a corresponding materializer of the one or more materializers, wherein generating the one or more semantic objects comprises generating each semantic object of the one or more semantic objects using the corresponding materializer based on the transaction.

12. The system of claim 10, wherein transmitting the transaction comprises:
generating, based on the transaction, one or more data capture transactions, wherein each of the one or more data capture transactions comprise at least a subset of the one or more data operations; and
for each data capture transaction of the one or more data capture transactions:
identifying, by a dispatcher, a semantic object queue corresponding to a relevant materializer of the one or more materializers, and
appending the data capture transaction to the semantic object queue corresponding to the relevant materializer.

13. The system of claim 10, wherein generating the one or more semantic objects comprises, for each materializer of the one or more materializers:
identifying a primary key associated with the transaction, wherein the primary key corresponds to a semantic object;
determining, based on the second schema, one or more relevant values associated with the primary key;
retrieving the one or more relevant values from the replica data store;
determining a watermark based on the retrieving, wherein the watermark comprises a timestamp; and
generating the semantic object based on the one or more relevant values and the watermark.

14. The system of claim 13, wherein the operations further comprise:
receiving, at the data storage system, a second source data write from the source data store, wherein the second source data write corresponds to the one or more semantic objects;
generating a version of the one or more semantic objects based on the second source data write, wherein the version is associated with a second watermark;
determining whether the watermark is greater than the second watermark;
responsive to determining the watermark is greater than the second watermark, writing the one or more semantic objects to the one or more target data stores; and
responsive to determining the watermark is not greater than the second watermark, executing the second source data write on the one or more target data stores.

15. The system of claim 10, wherein the source data write is a duplicated write from the data storage system, and wherein the computer-implemented method further comprises:
receiving, at the data storage system, a direct data write;
generating the source data write based on the direct data write;
transmitting the duplicated write to the source data store;
generating a placeholder watermark based on the direct data write and a current time value;
determining whether the placeholder watermark corresponds to an expected watermark value; and
responsive to determining the placeholder watermark corresponds to the expected watermark value, executing the direct data write on the one or more target data stores.

16. One or more non-transitory computer-readable media storing instructions which, when executed by one or more processors, cause the one or more processors to perform operations comprising:
receiving, by a data storage system, a source data write from a source data store, wherein:
the source data store is associated with a first schema, and
the data storage system is associated with a second schema that is different from the first schema;
executing the source data write on a replica data store of the data storage system, wherein the replica data store is associated with the first schema;
determining a transaction based on one or more data operations of the source data write;
identifying, by a router, one or more materializers based on the transaction and a mapping between the first schema and the second schema;
transmitting, by the router, the transaction to the one or more materializers;
generating, by the one or more materializers, one or more semantic objects based on the transaction; and
transmitting the one or more semantic objects to one or more target data stores of the data storage system, wherein the one or more target data stores are associated with the second schema.

17. The one or more non-transitory computer-readable media of claim 16, wherein identifying the one or more materializers comprises:
identifying, based on the transaction, one or more updated tables corresponding to the first schema;
identifying, based on the mapping, one or more concepts associated with the one or more updated tables, wherein the one or more concepts are defined by the second schema;
determining, based on the one or more concepts, the one or more semantic objects; and
identifying, for each semantic object of the one or more semantic objects, a corresponding materializer of the one or more materializers, wherein generating the one or more semantic objects comprises generating each semantic object of the one or more semantic objects using the corresponding materializer based on the transaction.

18. The one or more non-transitory computer-readable media of claim 16, wherein transmitting the transaction comprises:
generating, based on the transaction, one or more data capture transactions, wherein each of the one or more data capture transactions comprise at least a subset of the one or more data operations; and
for each data capture transaction of the one or more data capture transactions:
identifying, by a dispatcher, a semantic object queue corresponding to a relevant materializer of the one or more materializers, and
appending the data capture transaction to the semantic object queue corresponding to the relevant materializer.

19. The one or more non-transitory computer-readable media of claim 16, wherein generating the one or more semantic objects comprises, for each materializer of the one or more materializers:
identifying a primary key associated with the transaction, wherein the primary key corresponds to a semantic object;
determining, based on the second schema, one or more relevant values associated with the primary key;
retrieving the one or more relevant values from the replica data store;
determining a watermark based on the retrieving, wherein the watermark comprises a timestamp; and
generating the semantic object based on the one or more relevant values and the watermark.

20. The one or more non-transitory computer-readable media of claim 16, wherein the operations further comprise:
receiving, at the data storage system, a second source data write from the source data store, wherein the second source data write corresponds to the one or more semantic objects;
generating a version of the one or more semantic objects based on the second source data write, wherein the version is associated with a second watermark;
determining whether the watermark is greater than the second watermark;
responsive to determining the watermark is greater than the second watermark, writing the one or more semantic objects to the one or more target data stores; and
responsive to determining the watermark is not greater than the second watermark, executing the second source data write on the one or more target data stores.
